(19) United States
(12) Patent Application Publication
(10) Pub. No.: US 2019/0122228 A1
(43) Pub. Date: Apr. 25, 2019

(54) EXAMINATION DEVICE

(71) Applicant: NEC Corporation, Tokyo (JP)

(72) Inventor: Yusuke KONISHI, Tokyo (JP)

(73) Assignee: NEC Corporation, Tokyo (JP)

(21) Appl. No.: 16/094,513

(22) PCT Filed: Apr. 13, 2017
(86) PCT No.: PCT/JP2017/015076

§ 371 Date: Oct. 18, 2018

(30) Foreign Application Priority Data
Apr. 19, 2016 (JP) 2016-083313

(51) Int. Cl. G06Q 30/02; G06Q 50/10; G06T 7/60; G08G 1/01

(52) U.S. Cl. CPC G06Q 30/02; G08G 1/01; G06T 7/60; G06Q 50/10

(57) ABSTRACT

The examination device 300 is equipped with a detection unit 310, a movement number calculation unit 320, and an estimation unit 330. The detection unit 310 detects identifier-carrying objects in each of first and second areas in which the identifier-carrying objects that are easy to identify are mixed with non-identifier-carrying objects that are hard to identify. The movement number calculation unit 320 calculates, on the basis of the detection results, the number of identifier-carrying objects that have moved from the first area into the second area. The estimation unit 330 estimates, on the basis of the calculated movement number of the identifier-carrying objects and the ratio between the identifier-carrying objects and the non-identifier-carrying objects in each area, the total number of the identifier-carrying objects and the non-identifier-carrying objects that have moved from the first area into the second area.

### TECHNICAL FIELD

The present invention relates to a technology of examining a flow of an object by an examination device.

### BACKGROUND ART

Examinations of a number of persons existing in a specific area, a number of persons moving between specific areas, and the like have been performed for purposes of a traffic survey, facility management, marketing research, and the like. And then, technologies automating such examinations include a technology described in PTL 1.

In the technology described in PTL 1, every time a person carrying a personal handy-phone system (PHS) terminal newly enters each service area in a PHS network for business premises, a PHS exchange acquires moving route information including time information, a terminal identification number, immediately preceding positional information, and latest positional information. Then, the PHS exchange records the acquired moving route information into a storage device. By reading thus recorded moving route information from the storage device through a maintenance terminal and analyzing the information, an examination result of a flow of person can be acquired in a simplified manner.

### CITATION LIST

### Patent Literature

[PTL 1]: Japanese Unexamined Patent Application Publication No. 2000-236570

[PTL 2]: Japanese Patent No. 4165524

[PTL 3]: Japanese Unexamined Patent Application Publication No. 2012-252654

### SUMMARY OF INVENTION

### Technical Problem

Although the technology described in PTL 1 can examine a flow of person carrying PHS terminal, the technology cannot examine a flow of persons when person carrying PHS terminal and person not carrying PHS terminal coexist. The reason is that, even when a person not carrying a PHS terminal newly enters each service area, a moving route cannot be acquired by identifying an individual as is the case with a person carrying a PHS terminal. Such an issue occurs not only when examining a flow of person but also when examining a flow of object other than person, such as vehicle and animal.

The present invention has been conceived in order to resolve the issue described above. Specifically, a main object of the present invention is to provide a technology of examining a flow of objects when objects that are easy to be individually identified and objects that are difficult to be individually identified coexist.

### Solution to Problem

An examination device of an example embodiment includes:
a detection unit that detects an identified object in a first area and a second area, the identified object being individually identifiable object, the first area and the second area being areas where the identified object and an unidentified object difficult to individually identify coexist;
a movement count calculation unit that calculates a movement count of the identified object that moves from the first area to the second area using a detection result by the detection means; and
an estimation unit that estimates a total movement count of the identified object and the unidentified object that move from the first area to the second area using the calculated movement count of the identified object and a ratio between the identified object and the unidentified object for each of the areas.

An examination method of an example embodiment includes:
detecting an identified object in a first area and a second area, the identified object being individually identifiable object, the first area and the second area being areas where the identified object and an unidentified object difficult to individually identify coexist;
calculating a movement count of the identified object that moves from the first area to the second area using a result of the detection; and
estimating a total movement count of the identified object and the unidentified object that move from the first area to the second area using the calculated movement count of the identified object and a ratio between the identified object and the unidentified object for each of the areas.

A program storage medium of an example embodiment stores a computer program for causing a computer to execute:
detecting an identified object in a first area and a second area, the identified object being individually identifiable object, the first area and the second area being areas where the identified object and an unidentified object difficult to individually identify coexist;
calculating a movement count of the identified object that moves from the first area to the second area using a result of the detection; and
estimating a total movement count of the identified object and the unidentified object that move from the first area to the second area using the calculated movement count of the identified object and a ratio between the identified object and the unidentified object for each of the areas.

### Advantageous Effects of Invention

The present invention can examine a flow rate of objects when objects that are easy to be individually identified and objects that are difficult to be individually identified coexist.

### BRIEF DESCRIPTION OF DRAWINGS

FIG. 1 is a diagram illustrating a system configuration according to a first example embodiment of the present invention.

FIG. 2 is a block diagram illustrating a simplified configuration of an examination device according to the first example embodiment.

FIG. 3 is a diagram illustrating an example of count data of objects according to the first example embodiment.

FIG. 4 is a diagram illustrating an example of detection data of objects according to the first example embodiment.

FIG. 5 is a diagram illustrating an example of movement count data of objects according to the first example embodiment.

FIG. 6 is a diagram illustrating an example of ratio data according to the first example embodiment.

FIG. 7 is a diagram illustrating an example of total movement count data of objects, according to the first example embodiment.

FIG. 8 is a flowchart illustrating an operation example of a total count detection unit according to the first example embodiment.

FIG. 9 is a flowchart illustrating an operation example of a detection unit according to the first example embodiment.

FIG. 10 is a flowchart illustrating an operation example of a movement count calculation unit according to the first example embodiment.

FIG. 11 is a flowchart illustrating an operation example of a ratio calculation unit according to the first example embodiment.

FIG. 12 is a flowchart illustrating an operation example of an estimation unit according to the first example embodiment.

FIG. 13 is a flowchart illustrating an operation example of a control unit according to the first example embodiment.

FIG. 14 is a diagram illustrating a system configuration according to a second example embodiment of the present invention.

FIG. 15 is a block diagram illustrating a simplified configuration of an examination device according to the second example embodiment.

FIG. 16 is a diagram illustrating an example of passage data according to the second example embodiment.

FIG. 17 is a diagram illustrating an example of count data according to the second example embodiment.

FIG. 18 is a diagram illustrating an example of detection data according to the second example embodiment.

FIG. 19 is a diagram illustrating an example of movement count data according to the second example embodiment.

FIG. 20 is a diagram illustrating an example of ratio data according to the second example embodiment.

FIG. 21 is a diagram illustrating an example of total movement count data according to the second example embodiment.

FIG. 22 is a flowchart illustrating an operation example of a passage detection unit according to the second example embodiment.

FIG. 23 is a flowchart illustrating an operation example of a per-attribute total count detection unit according to the second example embodiment.

FIG. 24 is a flowchart illustrating an operation example of a per-attribute detection unit according to the second example embodiment.

FIG. 25 is a flowchart illustrating an operation example of a per-attribute movement count calculation unit according to the second example embodiment.

FIG. 26 is a flowchart illustrating an operation example of a per-attribute ratio calculation unit according to the second example embodiment.

FIG. 27 is a flowchart illustrating an operation example of a per-attribute estimation unit according to the second example embodiment.

FIG. 28 is a flowchart illustrating an operation example of a control unit according to the second example embodiment.

FIG. 29 is a diagram illustrating an operation of calculating a movement count of objects moving between areas according to the second example embodiment.

FIG. 30 is a block diagram illustrating a simplified configuration of an examination device according to a third example embodiment of the present invention.

FIG. 31 is a diagram illustrating a system configuration according to another example embodiment of the present invention.

FIG. 32 is a diagram illustrating an example of an authentication table used in the other example embodiment of the present invention.

FIG. 33 is a diagram illustrating a system configuration according to another example embodiment of the present invention.

### EXAMPLE EMBODIMENT

Next, example embodiments of the present invention will be described in detail with reference to drawings.

### First Example Embodiment

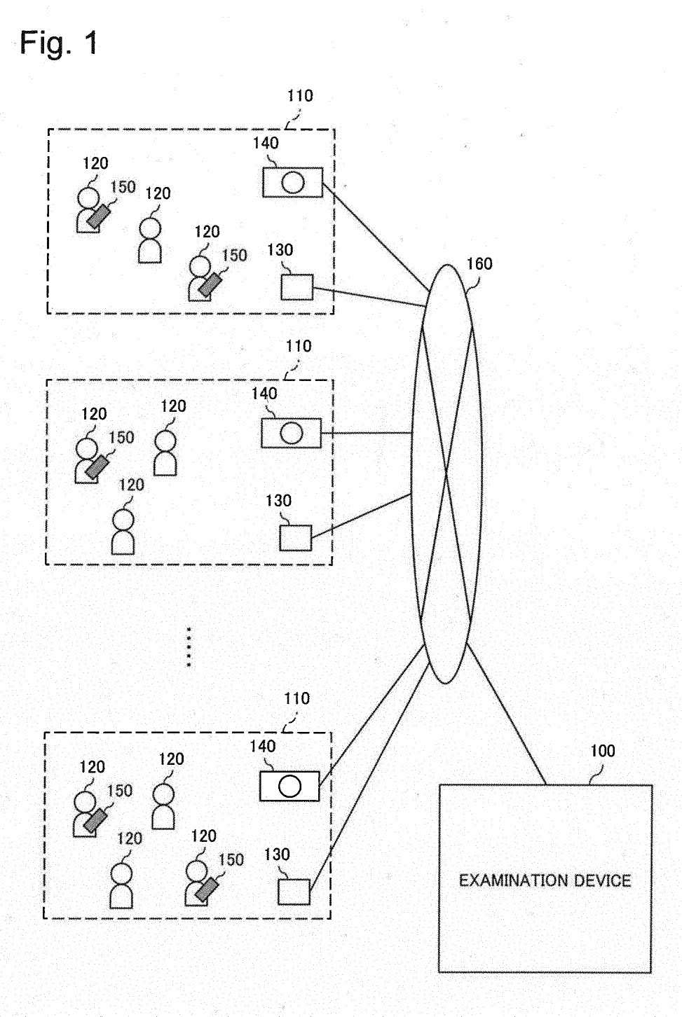

Referring to FIG. 1, an examination device 100 according to a first example embodiment of the present invention is a device that examines a flow rate of person 120 moving between areas 110. The person is also referred to as an object.

The area 110 is a space that is partitioned by a physical member, such as a building, a floor in a building, or a room on a floor. Alternatively, the area 110 may be a specified area in a space not partitioned by a physical member, such as a station square or a rotary.

A sensor 130 and a surveillance camera 140 are placed in each area 110. The sensor 130 has a function of identifying a mobile terminal (e.g. a smartphone) 150 carried by a person 120 existing in the area 110. The surveillance camera 140 has a function of detecting a number of persons 120 existing in the area 110.

Specifically, the sensor 130 has a function of detecting a wireless local area network (LAN) frame transmitted by the mobile terminal 150 existing in the area 110 and acquiring information by which the terminal can be identified from the frame (hereinafter referred to as terminal identification information). Further, the sensor 130 has a function of transmitting an object detection result including identification information of the area 110 and the aforementioned acquired terminal identification information to the examination device 100 through a wireless network 160. When a detection range in which the sensor 130 can detect a wireless LAN frame covers the entire area 110, only one sensor 130 may be installed in one area 110. However, when the detection range of the wireless LAN frame by the sensor 130 cannot cover the entire area 110, a plurality of sensors 130 are installed at different locations in the area 110 in such a way as to cover the entire area 110.

The surveillance camera 140 has a function of detecting a person himself/herself, an occupied area by the person with respect to an entire screen, and the like, by analyzing an image acquired through capturing inside the area 110. Further, the surveillance camera 140 has a function of detecting the number of persons 120 existing in the area 110 using the detection result. Additionally, the surveillance camera 140 has a function of transmitting a count detection result including identification information of the area 110 and the detected number of persons to the examination device 100 through the wireless network 160. When a surveillance range of the surveillance camera 140 covers the entire area 110, only one surveillance camera 140 may be installed in one area 110. However, when the surveillance range of the surveillance camera 140 cannot cover the entire area 110, a plurality of surveillance cameras 140 are installed at different locations in the area 110 in such a way as to cover the entire area 110.

The examination device 100 has a function of calculating the flow rate of person 120 moving between the areas 110 using an object detection result and a count detection result that are transmitted from a sensor 130 and a surveillance camera 140 in each area 110.

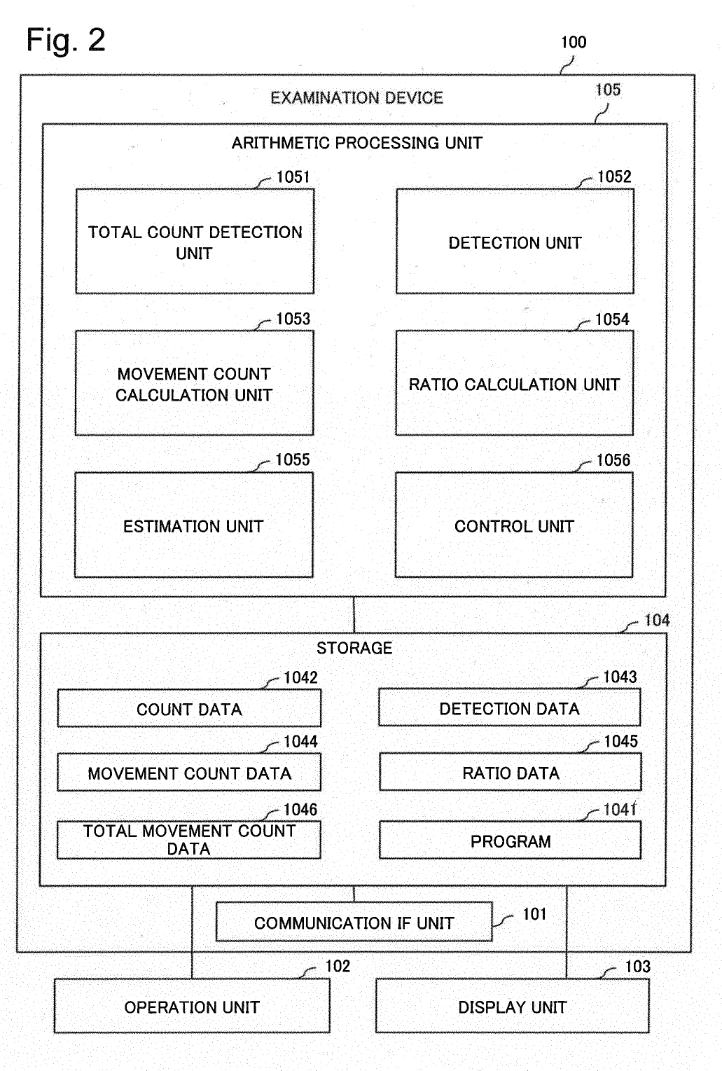

FIG. 2 is a block diagram illustrating a simplified configuration of the examination device 100. Referring to FIG. 2, the examination device 100 includes a communication interface (IF) unit 101, a storage 104, and an arithmetic processing unit 105, and is connected to an operation unit 102 and a display unit 103.

The communication IF unit 101 includes a dedicated data communication circuit and has a function of performing data communication with various types of devices such as the sensor 130 and the surveillance camera 140 that are connected through a wireless communication line.

The operation unit 102 includes operation input devices such as a keyboard and a mouse, and has a function of detecting an operation by an operator and outputting a signal in response to the operation to the arithmetic processing unit 105.

The display unit 103 includes a screen display device such as a liquid crystal display (LCD) and has a function of displaying on a screen various types of information such as the flow rate of people between areas 110, in response to an instruction from the arithmetic processing unit 105.

The storage 104 includes a storage device such as a hard disk and a memory, and has a function of storing data and a computer program (program) 1041 that are required for various types of processing in the arithmetic processing unit 105. The program 1041 is a program providing various types of processing units by being read and executed by the arithmetic processing unit 105. The program 1041 is acquired from an external device (unillustrated) or a storage medium (unillustrated) through a data input-output function such as the communication IF unit 101 and is saved into the storage 104. Further, main data stored in the storage 104 include count data 1042, detection data 1043, movement count data 1044, ratio data 1045, and total movement count data 1046.

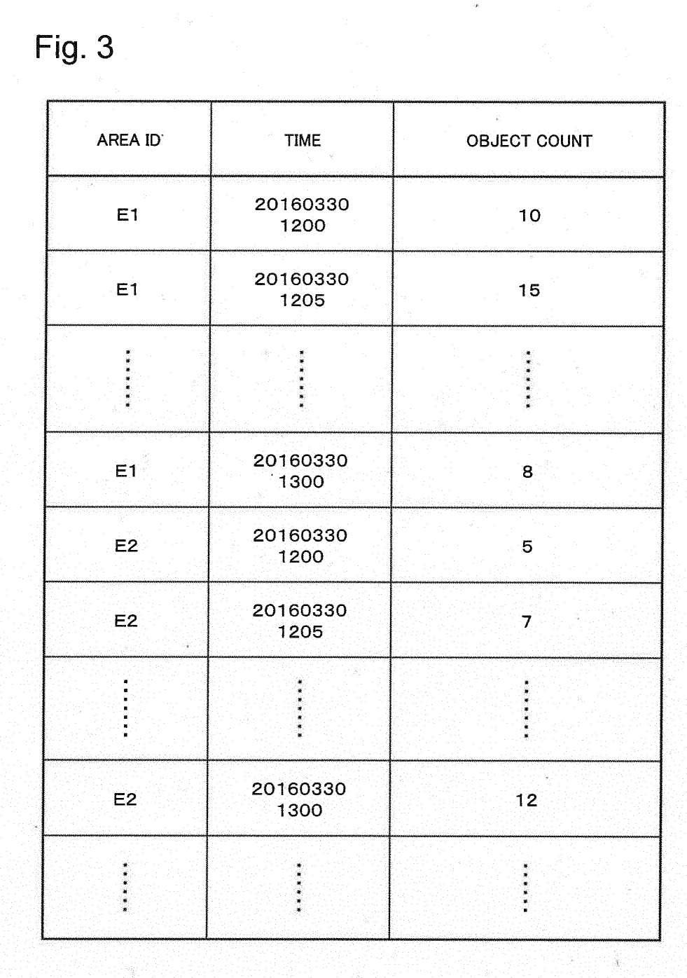

The count data 1042 is information representing the number of persons 120 which exists in the area 110 and is detected by the surveillance camera 140. FIG. 3 illustrates an example of the count data 1042. The count data 1042 in this example include a plurality of entries. Note that a combination of a plurality of data associated with one another is herein referred to as an entry. For example, an area identification (ID), time data, and data of a number of persons (object count) detected by the surveillance camera 140 are associated with one another in the count data 1042, and the combination of the data is the entry. The area ID is identification information on identifying the area 110 in which the number of persons is detected. The object count represents the number of persons detected by the surveillance camera 140. The time data represents a time when the number of persons is detected. For example, the entry in the second row in FIG. 3 represents that, at a time point 12:00 on Mar. 30, 2016, 10 persons exist in the area 110 where an area ID is E1.

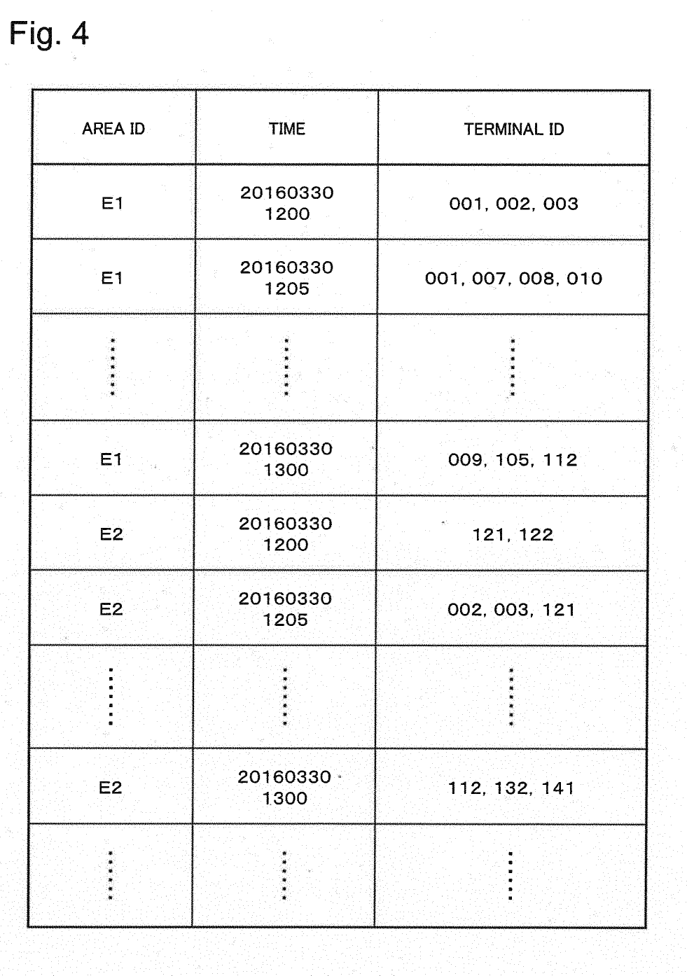

The detection data 1043 are information representing terminal identification (terminal ID) information. The terminal identification (terminal ID) information is identification information on identifying a mobile terminal 150 carried by the person 120 which exists in the area 110 and is detected by the sensor 130. FIG. 4 illustrates an example of the detection data 1043. The detection data 1043 in this example are composed of a plurality of entries, and each entry is a combination of data associated with the area ID, time data, and the terminal ID detected by the sensor 130. The area ID is identification information on identifying the area 110 where the terminal ID is detected. The terminal ID is terminal identification information acquired from the mobile terminal 150 by the sensor 130. The time represents a time when the terminal ID is detected. For example, the entry in the second row in FIG. 4 represents that the persons 120 carrying the mobile terminal 150 with terminal IDs “001,” “002,” and “003” exist in the area 110 with the area ID E1 at a time point 12:00 on Mar. 30, 2016.

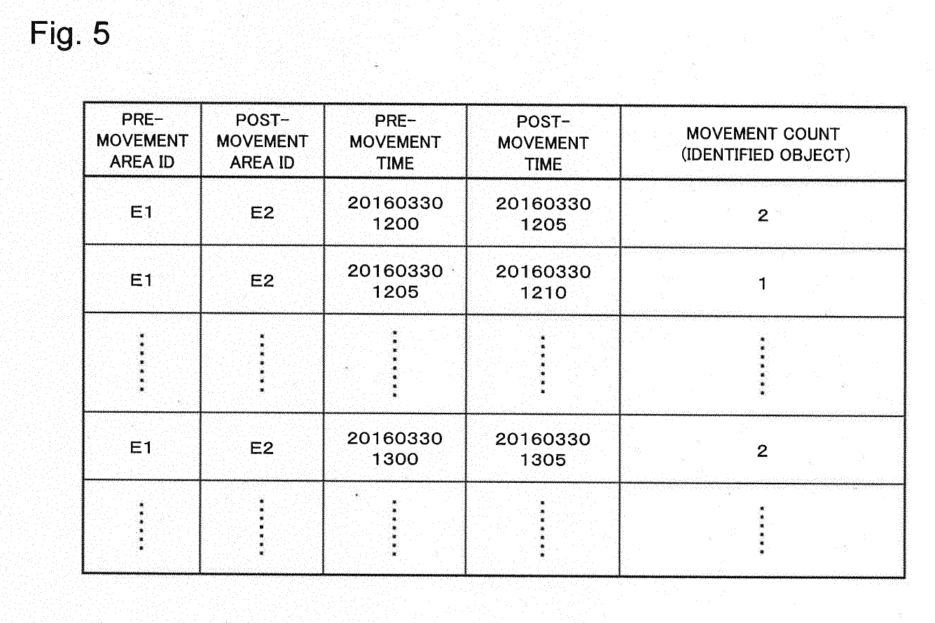

The movement count data 1044 are information representing the number (movement count) of persons 120 moving between the areas 110 and also carrying the mobile terminal 150 (hereinafter also referred to as identified objects). FIG. 5 illustrates an example of the movement count data 1044. The movement count data 1044 in this example are composed of a plurality of entries, and each entry is a combination of data associated with a pre-movement area ID, a post-movement area ID, a pre-movement time, a post-movement time, and movement count of persons (identified objects) 120 moving between areas 110 and also carrying the mobile terminal 150. The pre-movement area ID and the post-movement area ID are identification information on identifying the area 110 before movement and the area 110 after the movement, respectively. Data of the pre-movement time and the post-movement time represent a time before the movement and a time after the movement, respectively. The movement count is a number of persons (identified objects) 120 carrying the mobile terminal 150 and also moving from the area 110 with the pre-movement area ID at the pre-movement time to the area 110 with the post-movement area ID at the post-movement time. For example, the entry in the second row in FIG. 5 represents that, out of identified objects 120 existing in the area 110 with the area ID E1 at a time point 12:00 on Mar. 30, 2016, a number of identified objects 120 moving to the area 110 with the area ID E2 at a time point 12:05 on the same day in the same year is two.

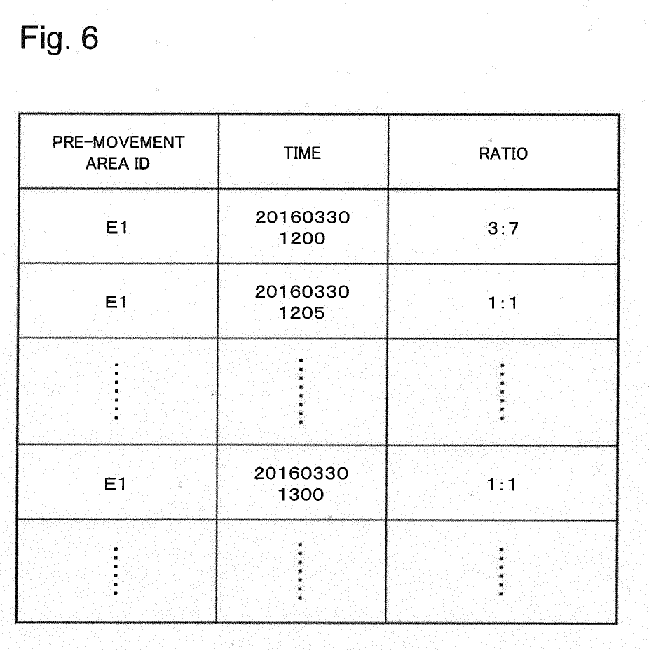

The ratio data 1045 are information representing a ratio between the number of persons (identified objects) 120 carrying the mobile terminals 150 and the number of persons not carrying the mobile terminals 150 (hereinafter the person not carrying the mobile terminal 150 is also referred to as unidentified object). FIG. 6 illustrates an example of the ratio data 1045. The ratio data 1045 in this example are composed of a plurality of entries, and each entry is a combination of data associated with the area ID, time data, and a ratio. The area ID is identification information on identifying the area 110 where the ratio is detected. The ratio represents a ratio of the number of persons between identified object and unidentified object. The time data represent a time when the ratio is detected. For example, the entry in the second row in FIG. 6 represents that the ratio between the number of persons (identified objects) 120 carrying the mobile terminals 150 and the number of persons (unidentified objects) 120 not carrying the mobile terminals 150 in the area 110 with the area ID E1 at a time point 12:00 on Mar. 30, 2016 is 3:7.

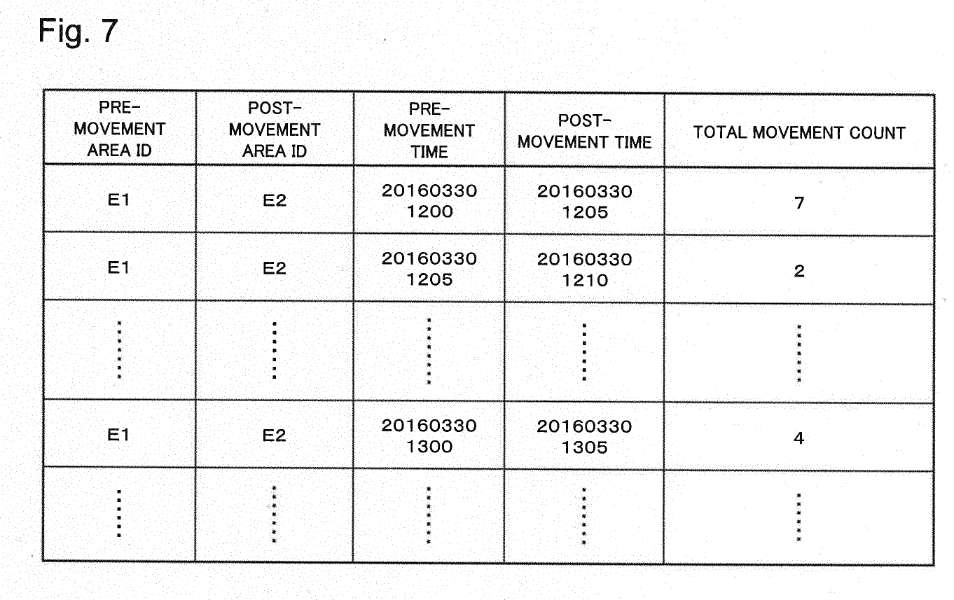

The total movement count data 1046 are information representing the number of persons 120 moving between the areas 110, that is, an estimated total count (total movement count) of persons (identified objects) carrying the mobile terminals 150 and persons (unidentified objects) not carrying the mobile terminals 150. FIG. 7 illustrates an example of the total movement count data 1046. The total movement count data 1046 in this example are composed of a plurality of entries, and each entry is a combination of data associated with the pre-movement area ID, the post-movement area ID, the pre-movement time, the post-movement time, and total movement count. Meanings of the pre-movement area ID, the post-movement area ID, the pre-movement time, and the post-movement time are the same as those of the pre-movement area ID, the post-movement area ID, the pre-movement time, and the post-movement time in the movement count data 1044 illustrated in FIG. 5. The total movement count is the number of persons 120 moving to the area 110 specified by the post-movement area ID at the post-movement time, out of persons existing in the area 110 specified by the pre-movement area ID at the pre-movement time. For example, the entry in the second row in FIG. 7 represents that, out of persons 120 existing in the area 110 with the area ID E1 at a time point 12:00 on Mar. 30, 2016, the total movement count of persons 120 moving to the area 110 where the area ID is E2 at a time point 12:05 on the same day in the same year is estimated to be seven.

The arithmetic processing unit 105 includes a microprocessor such as a central processing unit (CPU) and a peripheral circuit of the microprocessor, and has a function of providing various types of processing units by causing hardware and the program 1041 to cooperate with one another by reading the program 1041 from the storage 104 and executing the program 1041. Main processing units provided by the arithmetic processing unit 105 include a total count detection unit 1051, a detection unit 1052, a movement count calculation unit 1053, a ratio calculation unit 1054, an estimation unit 1055, and a control unit 1056.

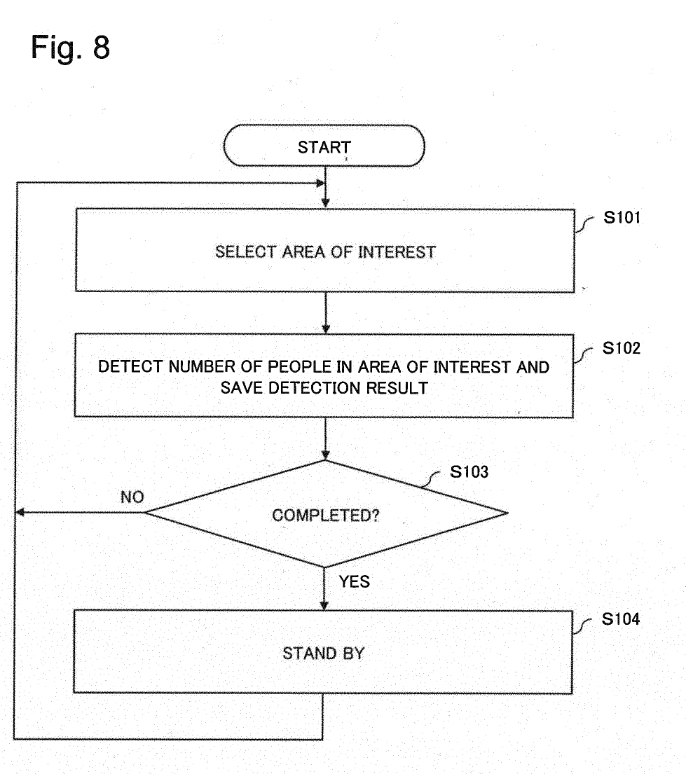

The total count detection unit 1051 has a function of detecting the number of persons 120 existing in the area 110 by use of the surveillance camera 140 and saving the detection result into the storage 104 as the count data 1042. FIG. 8 is a flowchart illustrating an operation example of the total count detection unit 1051.

Referring to FIG. 8, the total count detection unit 1051 first focuses attention on one area (hereinafter also referred to as an area of interest) 110 out of a plurality of areas 110 [selects the area of interest (S101)]. Subsequently, by use of the surveillance camera 140 installed in the area of interest 110, the total count detection unit 1051 detects the number of persons 120 existing in the area of interest 110. Then, the total count detection unit 1051 adds, to the count data 1042 in the storage 104, the combination of data (entry) associating the detected data of the number of persons with the area ID of the area of interest 110 and detection time data (S102). Thereafter, the total count detection unit 1051 determines whether selection of every area 110 as the area of interest is completed (S103). Then, when the selection of every area 110 as the area of interest is not completed (NO in S103), the total count detection unit 1051 returns to Step S101 in order to select a next area of interest and repeats processing similar to the processing in and after Step S101 described above. On the other hand, when the selection of every area 110 as the area of interest is completed (YES in S103), the total count detection unit 1051 stands by for a set time (S104), and subsequently returns to Step S101 and performs processing similar to the processing described above from the beginning.

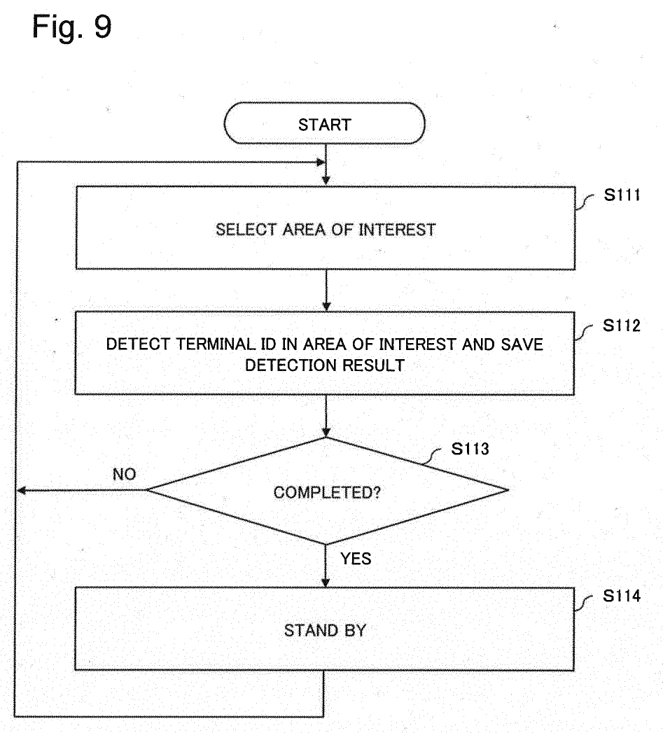

The detection unit 1052 has a function of detecting a person (identified object) 120 existing in the area 110 and also carrying the mobile terminal 150, by use of the sensor 130, and saving the detection result into the storage 104 as the detection data 1043. FIG. 9 is a flowchart illustrating an operation example of the detection unit 1052.

Referring to FIG. 9, the detection unit 1052 first selects the area 110 out of all areas 110 as the area of interest (S111). Subsequently, the detection unit 1052 detects the terminal identification information (terminal ID) of the mobile terminal 150 existing in the area of interest 110 by use of the sensor 130 installed in the area of interest 110, associates the area ID of the area of interest 110 and detection time data with the detected terminal ID, and adds the resulting data to the detection data 1043 in the storage 104 (S112). Thereafter, the detection unit 1052 determines whether selection of every area 110 as the area of interest is completed (S113). Then, when the selection of every area 110 as the area of interest is not completed (NO in S113), the detection unit 1052 returns to Step S111 in order to select a next area of interest and repeats processing similar to the processing described above. On the other hand, when the selection of every area 110 as the area of interest is completed (YES in S113), the detection unit 1052 stands by for a set time (S114), and subsequently returns to Step S111 and performs processing similar to the processing described above from the beginning.

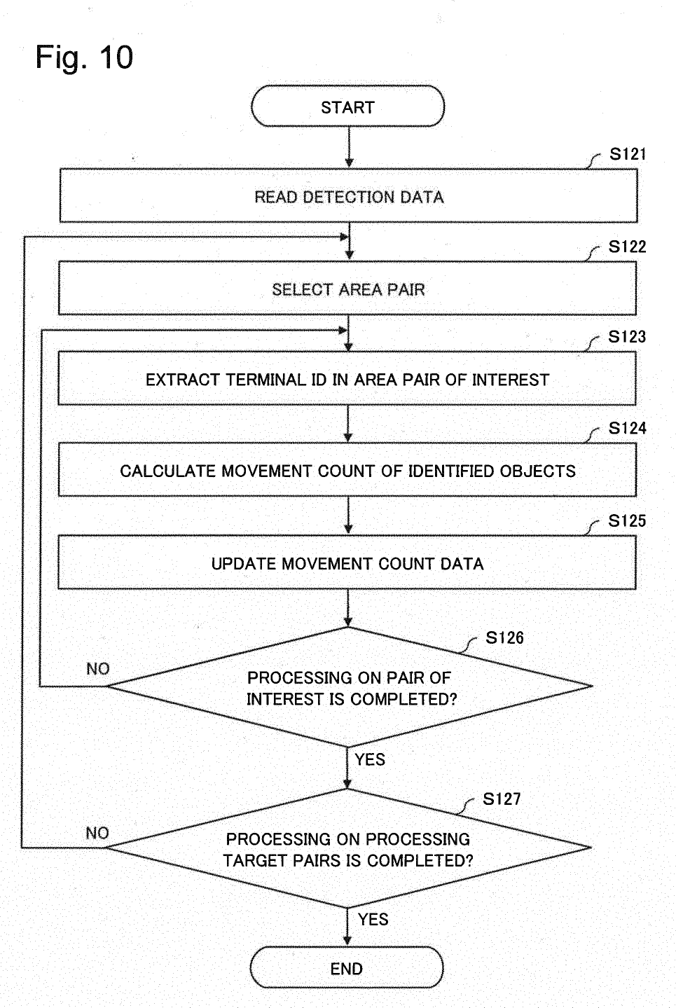

The movement count calculation unit 1053 has a function of generating information representing the movement count of persons (identified objects) 120 moving between areas 110 and also carrying the mobile terminals 150 using the detection data 1043 stored in the storage 104, and saving the information into the storage 104 as the movement count data 1044. FIG. 10 is a flowchart illustrating an operation example of the movement count calculation unit 1053.

Referring to FIG. 10, the movement count calculation unit 1053 first reads the detection data 1043 from the storage 104 (S121). Subsequently, the movement count calculation unit 1053 selects one area out of all areas 110 as the pre-movement area of interest and selects one area out of the other areas as the post-movement area of interest. In other words, the movement count calculation unit 1053 selects a pair of the pre-movement area and the post-movement area (S122). When n areas 110 exist, a total count of area pairs becomes n×(n−1). The movement count calculation unit 1053 sets the n×(n−1) pairs as processing targets. Alternatively, the movement count calculation unit 1053 sets pairs of adjacent areas as processing targets. The person 120 can directly move between adjacent areas without passing through another area. Information about pairs of adjacent areas may be previously given to the movement count calculation unit 1053 or may be calculated by the movement count calculation unit 1053 from positional information of areas or the like.

Subsequently, the movement count calculation unit 1053 extracts the terminal IDs related to the pre-movement area of interest and the post-movement area of interest from the read detection data 1043 (S123). For example, the movement count calculation unit 1053 extracts the terminal IDs associated with a time t in the pre-movement area of interest and terminal IDs associated with a time t+Δt in the post-movement area of interest. Note that Δt is a predetermined time (e.g. 5 minutes). Then, the movement count calculation unit 1053 extracts the terminal IDs existing in common in the terminal IDs related to the pre-movement area of interest and the terminal IDs related to the post-movement area of interest, and calculates the number of the extracted terminal IDs as the movement count of identified objects (S124). The movement count of identified objects represents a number of persons (identified objects) 120 moving from the pre-movement area of interest to the post-movement area of interest between the pre-movement time t and the post-movement time t+Δt. For example, it is assumed that the pre-movement area and the pre-movement time are E1 and 12:00 on Mar. 30, 2016, and the post-movement area and the post-movement time are E2 and 12:05 on Mar. 30, 2016. In the case of the detection data 1043 illustrated in FIG. 4, data of the pre-movement area E1 at the time 12:00 are associated with terminal IDs “001,” “002,” and “003”. Data of the post-movement area E2 at the time 12:05 are associated with terminal IDs “002,” “003,” and “121”. The terminal IDs existing in common in the terminal IDs before the movement and after the movement are “002” and “003,” and consequently, the movement count of the identified objects becomes two.

Then, the movement count calculation unit 1053 adds, to the movement count data 1044 in the storage 104, data (entry) associated with the area ID of the pre-movement area of interest 110, the area ID of the post-movement area of interest 110, the pre-movement time data, the post-movement time data, and the calculated movement count data [i.e. updates the movement count data 1044 (S125)].

Subsequently, the movement count calculation unit 1053 determines whether extraction of the terminal IDs and calculation of a movement count of identified objects are completed with respect to the pair of the pre-movement area of interest and the post-movement area of interest when the time is changed (S126). When the extraction and the calculation are not completed (NO in S126), the movement count calculation unit 1053 returns to Step S123, changes the time t, and repeats processing similar to the processing described above. On the other hand, when the extraction and the calculation are completed (YES in S126), the movement count calculation unit 1053 determines whether the movement count calculation processing is completed for every pair of areas being a processing target (S127). When the processing is not completed (NO in S127), the movement count calculation unit 1053 returns to Step S122 in order to select a next pair of areas of interest and repeats processing similar to the processing in and after Step S122 described above. When the movement count calculation processing is completed for every pair of areas being a processing target (YES in S127), the movement count calculation unit 1053 ends the movement count calculation processing.

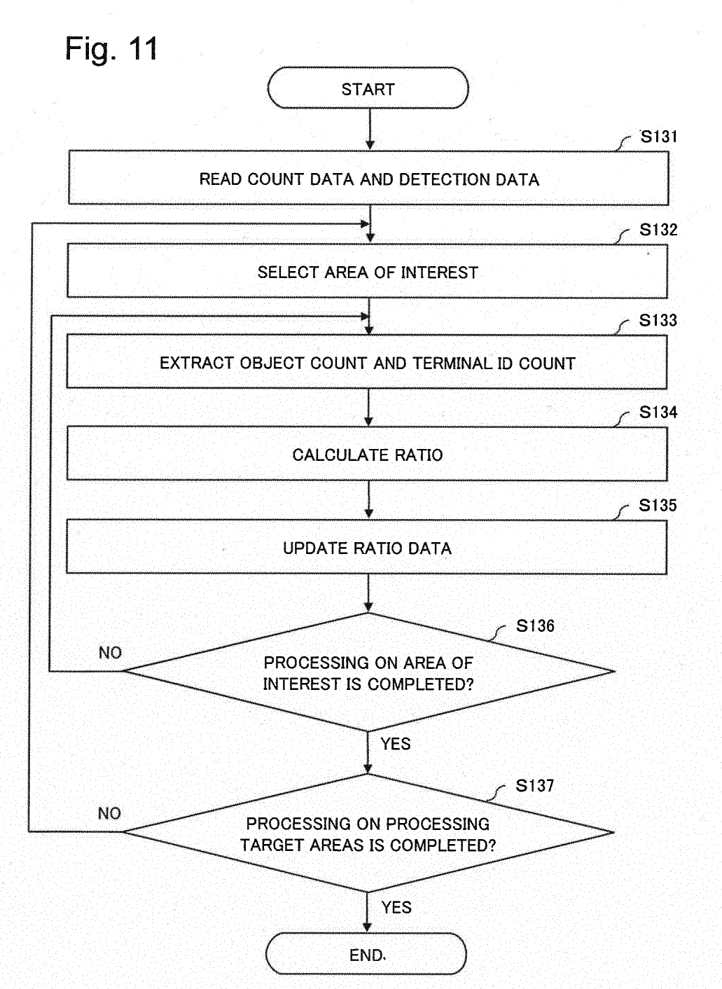

The ratio calculation unit 1054 has a function of calculating the ratio between the number of persons (identified objects) 120 carrying the mobile terminals 150 and the number of persons 120 (unidentified objects) not carrying the mobile terminals 150 using the count data 1042 and the detection data 1043 that are stored in the storage 104. FIG. 11 is a flowchart illustrating an operation example of the ratio calculation unit 1054.

Referring to FIG. 11, the ratio calculation unit 1054 first reads the count data 1042 and the detection data 1043 from the storage 104 (S131). Then, the ratio calculation unit 1054 selects one area 110 out of all areas 110 as the area of interest (S132). Subsequently, the ratio calculation unit 1054 extracts the object count in the count data associated with the same time, and the terminal ID count in the detection data (S133). The counts are related to the area of interest 110. Then, based on the extracted object count and terminal ID count, the ratio calculation unit 1054 calculates the ratio between the number of persons (identified objects) 120 carrying the mobile terminals 150 in the area of interest and the number of persons (unidentified objects) 120 not carrying the mobile terminals 150 at a time of interest (S134). For example, the object count in the count data 1042 in the area of interest E1 at a time 12:00 on Mar. 30, 2016 is 10, the terminal IDs in the detection data 1043 are “001,” “002,” and “003,” and the terminal ID count is three. In this case, the ratio calculation unit 1054 calculates the ratio between the number of persons (identified objects) 120 carrying the mobile terminals 150 and the number of persons (unidentified object) 120 not carrying the mobile terminals 150 in the area of interest E1 at a time 12:00 on Mar. 30, 2016 as 3:7.

Subsequently, the ratio calculation unit 1054 adds, to the ratio data 1045 in the storage 104, data associated with the area ID of the area of interest, the time of interest, and the calculated ratio [updates the ratio data 1045 (S135)]. Thereafter, the ratio calculation unit 1054 determines whether data related to an unprocessed time at which the ratio is not calculated in the area of interest exist [determines whether the ratio calculation processing in the area of interest is completed (S136)]. Then, when the processing is not completed (NO in S136), the ratio calculation unit 1054 returns to Step S133, changes the time, and repeats processing similar to the processing described above. On the other hand, when the ratio calculation processing in the area of interest is completed (YES in S136), the ratio calculation unit 1054 determines whether the ratio calculation processing is completed for every area 110 being a processing target (S137). Then, when the processing is not completed (NO in S137), the ratio calculation unit 1054 returns to Step S132 in order to select a next area of interest and performs processing similar to the processing in and after Step S132 described above. On the other hand, when the ratio calculation processing 110 is completed for every area (YES in S137), the ratio calculation unit 1054 ends the ratio calculation processing.

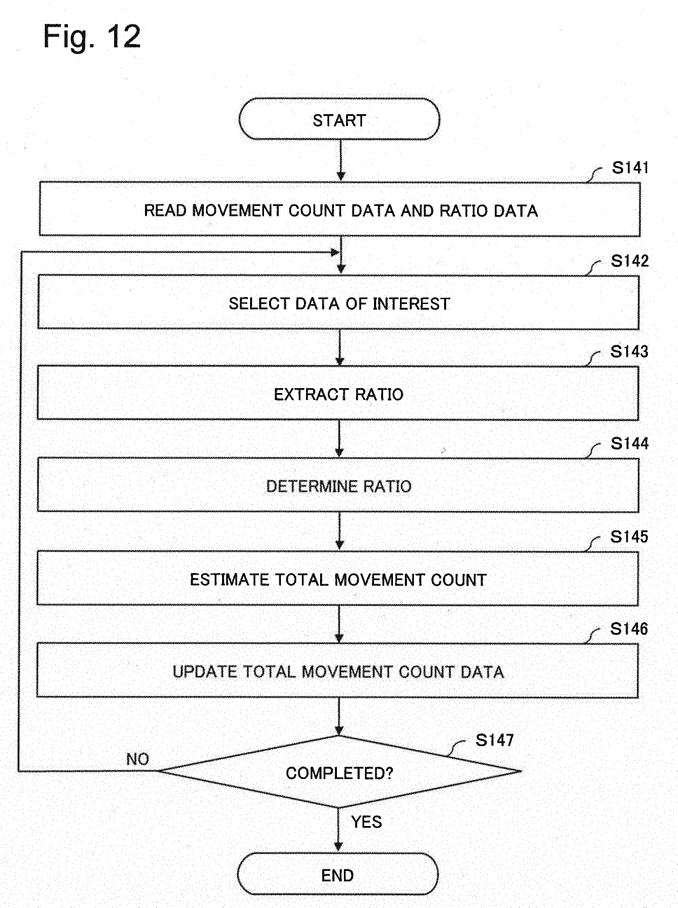

The estimation unit 1055 has a function of estimating the flow rate of person 120 moving between areas 110 using the movement count data 1044 and the ratio data 1045 that are stored in the storage 104, and saving the estimation result into the storage 104. FIG. 12 is a flowchart illustrating an operation example of the estimation unit 1055.

Referring to FIG. 12, the estimation unit 1055 first reads the movement count data 1044 and the ratio data 1045 from the storage 104 (S141). Subsequently, the estimation unit 1055 selects as data of interest a piece of data (entry) related to the pre-movement area ID, the post-movement area ID, the pre-movement time, and the post-movement time in the movement count data 1044 (S142). Then, the estimation unit 1055 extracts the ratio from the ratio data 1045 based on the pre-movement area ID, the post-movement area ID, the pre-movement time, and the post-movement time of the data of interest (S143). For example, the estimation unit 1055 extracts the ratio associated with the area ID and a time matching the pre-movement area ID and the pre-movement time in the ratio data 1045, and the ratio associated with the area ID and a time matching the post-movement area ID and the post-movement time in the ratio data 1045. Alternatively, the estimation unit 1055 extracts the ratio associated with the area ID and a time matching the pre-movement area ID and the pre-movement time in the ratio data 1045. Alternatively, the estimation unit 1055 extracts the ratio associated with the post-movement area ID and the post-movement time in the ratio data 1045.

Subsequently, the estimation unit 1055 determines a ratio used for the processing using the extracted ratio (S144). For example, when there is one ratio extracted from the ratio data, the estimation unit 1055 determines the extracted ratio is the ratio used for the processing. Further, when there are two ratios extracted from the ratio data, the estimation unit 1055 determines, for example, an average value, a maximum value, or a minimum value of the two extracted ratios is the ratio used for the processing.

Next, based on an object count (movement count) associated with the data of interest in the movement count data 1044, and the determined ratio, the estimation unit 1055 estimates the total movement count being a number of moving person by the following equation (S145).

total movement count=object count×(x+y)/x (1)

Note that x denotes a value of identified objects in the ratio between the number of persons (identified objects) carrying the mobile terminals 150 and the number of persons (unidentified objects) not carrying the mobile terminals 150, and y denotes a value of the unidentified objects in the ratio. For example, when the object count associated with data of interest in the movement count data is “3,” and the ratio x:y to be used is 3:7, the estimation unit 1055 estimates the total movement count to be 3×(3+7)/3=10.

Then, the estimation unit 1055 adds, to the total movement count data 1046 in the storage 104, data (entry) associating the estimated total movement count with the pre-movement area ID, the post-movement area ID, the pre-movement time, and the post-movement time of the data of interest [updates the total movement count data 1046 (S146)]. Then, the estimation unit 1055 determines whether data (entry) related to the pre-movement area ID, the post-movement area ID, the pre-movement time, and the post-movement time that are not used in the total movement count estimation exist in the movement count data 1044 (i.e. whether the total movement count estimation processing is completed) (S147). When the processing is not completed (NO in S147), the estimation unit 1055 returns to Step S142 in order to select next data of interest and repeats processing similar to the processing in and after Step S142 described above. On the other hand, when related data (entry) not used in the total movement count estimation do not exist (YES in S147), the estimation unit 1055 ends the total movement count estimation processing.

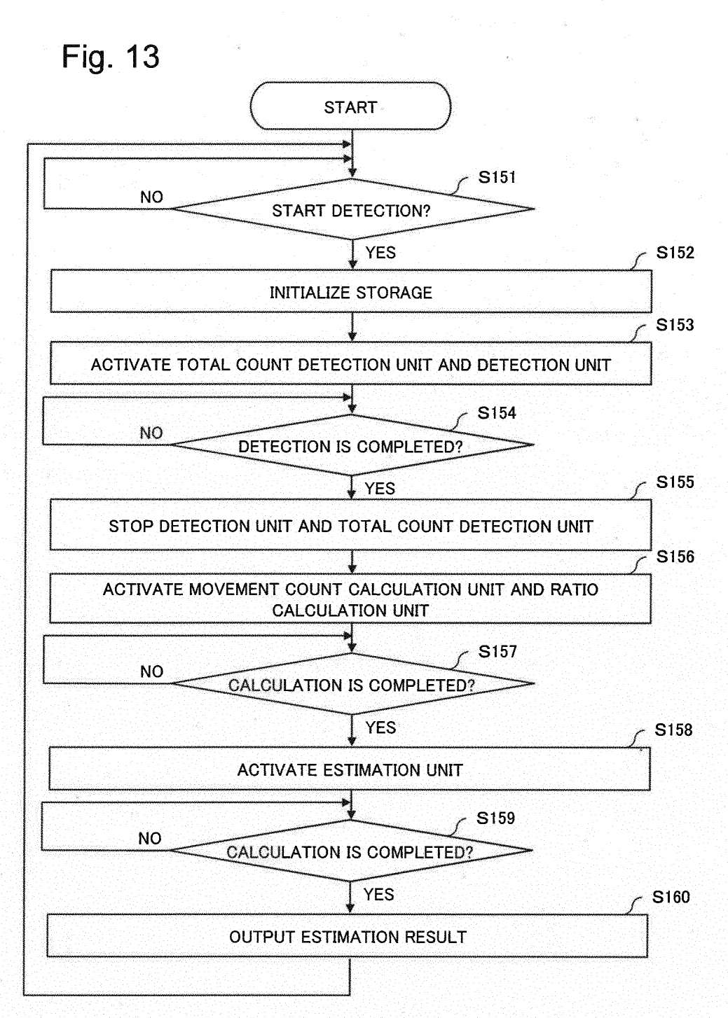

The control unit 1056 has a function of controlling the entire examination device 100. FIG. 13 is a flowchart illustrating an operation example of the control unit 1056. An entire operation of the examination device 100 will be described below with reference to FIG. 13.

Referring to FIG. 13, the control unit 1056 stands by in preparation for input of an instruction to start detection from a user through the operation unit 102 (S151). When the instruction to start detection is input, the control unit 1056 first initializes the storage 104 (S152). Consequently, the count data 1042, the detection data 1043, the movement count data 1044, the ratio data 1045, and the total movement count data 1046 are initialized. Subsequently, the control unit 1056 activates the total count detection unit 1051 and the detection unit 1052 (S153). Then, the control unit 1056 stands by in preparation for input of the instruction to end the detection from the user through the operation unit 102 (S154).

On the other hand, the activated total count detection unit 1051 starts the operation described with reference to FIG. 8 and detects the number of persons 120 existing in the area 110 by use of the surveillance camera 140. Then, the total count detection unit 1051 saves the detection result into the storage 104 by adding the result to the count data 1042 as illustrated in FIG. 3. Further, the activated detection unit 1052 starts the operation described with reference to FIG. 9, detects, by use of the sensor 130, person (identified object) 120 existing in the area 110 and also carrying the mobile terminal 150, and saves the detection result into the storage 104 as the detection data 1043 as illustrated in FIG. 4.

When an instruction to end the detection is input, the control unit 1056 stops the total count detection unit 1051 and the detection unit 1052 (S155). Consequently, the total count detection unit 1051 stops the operation described with reference to FIG. 8, and the detection unit 1052 stops the operation described with reference to FIG. 9. Subsequently, the control unit 1056 activates the movement count calculation unit 1053 and the ratio calculation unit 1054 (S156). Then, the control unit 1056 stands by until the operations are completed (S157).

On the other hand, the activated movement count calculation unit 1053 starts the operation described with reference to FIG. 10, generates information representing the number of persons 120 moving between areas 110 and also carrying the mobile terminals 150 using the detection data 1043 as illustrated in FIG. 4, and saves the information into the storage 104 as the movement count data 1044 as illustrated in FIG. 5. Further, the ratio calculation unit 1054 starts the operation described with reference to FIG. 11 and calculates the ratio between the number of persons (identified objects) 120 carrying the mobile terminals 150 and the number of persons (unidentified objects) 120 not carrying the mobile terminals 150 using the count data 1042 as illustrated in FIG. 3 and the detection data 1043 as illustrated in FIG. 4. Then, the ratio calculation unit 1054 saves the calculation result into the storage 104 as the ratio data 1045 as illustrated in FIG. 6.

Subsequently, when detecting completion of the operations of the movement count calculation unit 1053 and the ratio calculation unit 1054, the control unit 1056 activates the estimation unit 1055 (S158). Then, the control unit 1056 stands by until the operation of the estimation unit 1055 is completed (S159).

On the other hand, the activated estimation unit 1055 starts the operation described with reference to FIG. 12, estimates the flow rate of person 120 moving between areas 110 using the movement count data 1044 as illustrated in FIG. 5 and the ratio data 1045 as illustrated in FIG. 6, and saves the estimation result into the storage 104 as the total movement count data 1046 as illustrated in FIG. 7.

When detecting completion of the operation of the estimation unit 1055, the control unit 1056 reads the total movement count data 1046 from the storage 104, transmits the data to an external terminal through the communication IF unit 101, and also displays the estimation result on the display unit 103 (S160). Then, the control unit 1056 returns to Step S151 and stands by until the instruction to start detection is input from a user through the operation unit 102.

Thus, the examination device 100 according to the first example embodiment can examine a flow of persons when person 120 moving between areas 110 and also carrying the mobile terminal 150 and person 120 moving between areas 110 and also not carrying the mobile terminal 150 coexist.

The reason is that the detection unit 1052 periodically identifies terminal ID of the mobile terminal 150 carried by person 120 existing in each area 110, and the movement count calculation unit 1053 calculates a number of persons moving between areas 110 and also carrying the mobile terminals 150 using the aforementioned detection result. Then, based on the calculated number of persons carrying the mobile terminals 150, and the ratio between the number of persons carrying mobile terminals and the number of person not carrying mobile terminals, the estimation unit 1055 estimates the total count of persons 120 moving between areas 110 and also carrying the mobile terminals 150, and persons 120 moving between areas 110 and also not carrying the mobile terminals 150. The estimation is based on an empirical rule that behaviors of many persons can be roughly inferred by behaviors of pat of the persons.

In the description above, the total count detection unit 1051 detects the number of persons 120 existing in the area 110 by use of the surveillance camera 140. However, the total count detection unit 1051 may detect the number of persons 120 existing in the area 110 by use of a means other than the surveillance camera 140. For example, the total count detection unit 1051 may detect the number of persons existing in an area by use of a technology of measuring a number of persons passing through an area by use of a sensor measuring a distance to an object by a laser, as described in PTL 2. Alternatively, the total count detection unit 1051 may detect the number of persons 120 existing in the area 110 using information about a number of persons reported in real time from an examiner terminal placed for each area 110. The examiner terminal is a wireless terminal operated by an examiner (person) and, for example, is configured to transmit a number of persons counted by the examiner himself/herself to the total count detection unit 1051 by wireless communication.

Further, while the ratio calculation unit 1054 calculates the ratio for each area 110 at each detection time, the unit may calculate the ratio common to every area 110 at each detection time, the ratio for each area 110 at every detection time, or the ratio common to every area 110 at every detection time. Alternatively, the ratio calculation unit 1054 may be omitted, and a predetermined ratio may be used in a fixed manner.

Further, the detection unit 1052 identifies whether the person 120 is an individually identifiable object, using the terminal identification information included in a wireless LAN frame transmitted from the mobile terminal 150. However, the method of detecting whether the person 120 is an individually identifiable object is not limited to the above and may be another method. For example, the detection unit 1052 may detect whether the person 120 is an individually identifiable object by detecting terminal identification information transmitted from a wireless terminal other than a mobile terminal carried by the person 120. Alternatively, the detection unit 1052 may detect whether the person 120 is an individually identifiable object (i.e. a preregistered person) by analyzing a facial image acquired through photographing by a camera.

Further, while an object is a person, according to the first example embodiment, the object is not limited to a person and may be a vehicle, an animal or the like. In a case of a vehicle, for example, the detection unit 1052 can detect whether the vehicle is an individually identifiable object by detecting the terminal identification information from a wireless frame transmitted from a wireless terminal equipped on the vehicle. Further, in a case of an animal, for example, the detection unit 1052 can detect whether the animal is an individually identifiable object by detecting the terminal identification information from the wireless frame transmitted from the wireless terminal attached to the animal.

### Second Example Embodiment

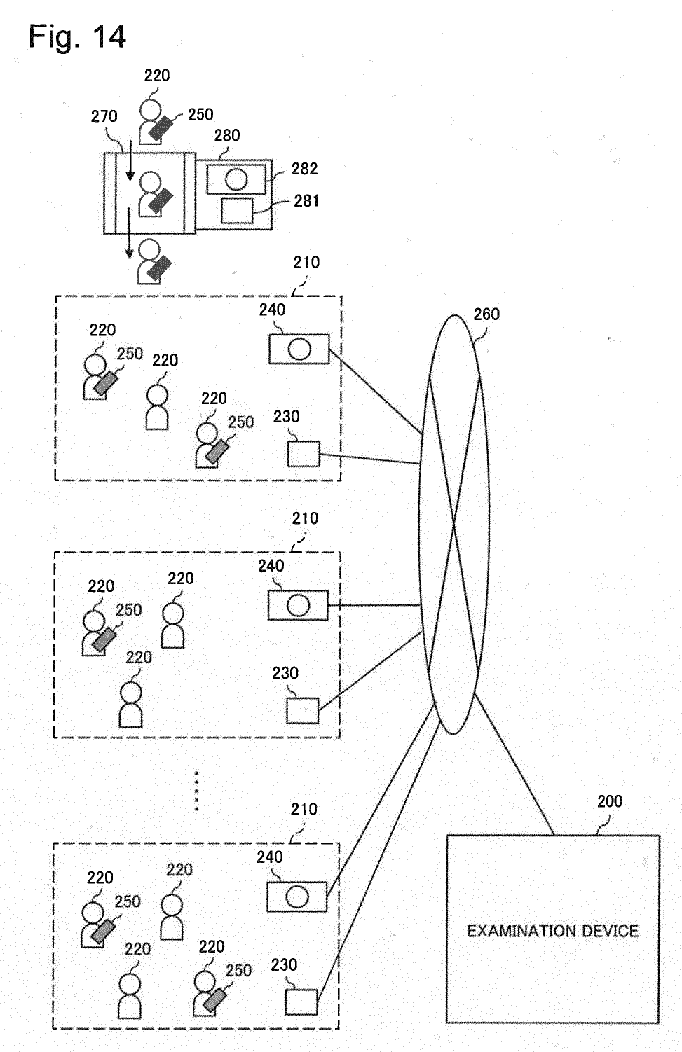

Referring to FIG. 14, an examination device 200 according to a second example embodiment of the present invention is a device examining, by attribute, the flow rate of person 220 moving between a plurality of areas 210. The second example embodiment uses sex as an attribute. However, the attribute of the person 210 is not limited to sex and may be another attribute such as age or race, or a combination of two or more types of attributes such as sex and age.

The area 210 is a space partitioned by a physical member, such as a building, a floor in a building, or a room on a floor. Alternatively, the area 210 may be a specified area in a space not partitioned by the physical member, such as a station square or a rotary.

A gate 270 is an entrance and exit through which the person 220 passes when entering any area 210. For example, the gate 270 may be an entrance of a building, an entrance of a hall, or a ticket gate at a station. The gate 270 has a shape and size allowing the person 220 to pass through the gate individually and sequentially, such as an automated ticket gate at a station. A passage detection device 280 of which a detection target is a person 220 passing through the gate is provided on the gate 270.

The passage detection device 280 includes a sensor 281 identifying a mobile terminal 250 carried by a person 220 passing through the gate 270 and a surveillance camera 282 detecting an attribute of the person 220.

The sensor 281 has a function of detecting the wireless LAN frame transmitted by a mobile terminal 250 carried by the person 220 passing through the gate 270 and acquiring terminal identification information (terminal ID) from the frame.

Further, the surveillance camera 282 has a function of extracting a facial feature from a facial image of the person 220 acquired through capturing the person passing through the gate 270 and detecting an attribute of the person using the facial feature. The technology of extracting the facial feature from the facial image of a person and detecting the attribute of the person, such as sex or age, using the facial feature, is known to the public by, for example, PTL 3, and therefore further description is omitted.

The passage detection device 280 has a function of, every time the person 220 passes through the gate 270, transmitting passage information on a detection result to the examination device 200 through a wireless network 260. The passage information includes a passage time, the detected attribute, information on whether the terminal identification information is detected, and the detected terminal identification information (terminal ID).

While one gate 270 is illustrated in FIG. 14, there may be a plurality of gates 270. In that case, the passage detection device 280 may exist for each gate 270.

In each area 210, a sensor 230 identifying the mobile terminal 250 carried by the person 220 existing in the area 210 and a surveillance camera 240 detecting, by attribute, the number of persons 220 existing in the area 210 are placed.

The sensor 230 has a function of detecting the wireless LAN frame transmitted by the mobile terminal 250 existing in the area 210 and acquiring the terminal identification information (terminal ID) from the frame. Further, the sensor 230 has a function of transmitting a detection result including the identification information (area ID) of the area 210 and the acquired terminal identification information (terminal ID) described above to the examination device 200 through the wireless network 260. When the wireless LAN frame detection range of the sensor 230 covers the entire area 210, only one sensor 230 may be installed in one area 210. However, when the wireless LAN frame detection range of the sensor 230 is narrower than the area 210, a plurality of sensors 230 are installed at different locations in the area 210 in such a way as to cover the entire area 210.

The surveillance camera 240 has a function of extracting the facial feature from the facial image of a person acquired through capturing inside the area 210, detecting the attribute of the person using the facial feature, and detecting, by the attribute, the number of persons 220 existing in the area 210. Further, the surveillance camera 240 has a function of transmitting the detection count result including identification information of the area 210 and the detected per-attribute number of persons described above to the examination device 200 through the wireless network 260. When the surveillance range of the surveillance camera 240 covers the entire area 210, only one surveillance camera 240 may be installed in one area 210. However, when the surveillance range of the surveillance camera 240 is narrower than the area 210, a plurality of surveillance cameras 240 are installed at different locations in the area 210 in such a way as to cover the entire area 210.

The examination device 200 has a function of calculating, by the attribute, the flow rate of person 220 moving between areas 210 using the passage information transmitted from the passage detection device 280 on the gate 270, and the detection result and the object count detection result that are transmitted from the sensor 230 and the surveillance camera 240 in each area 210.

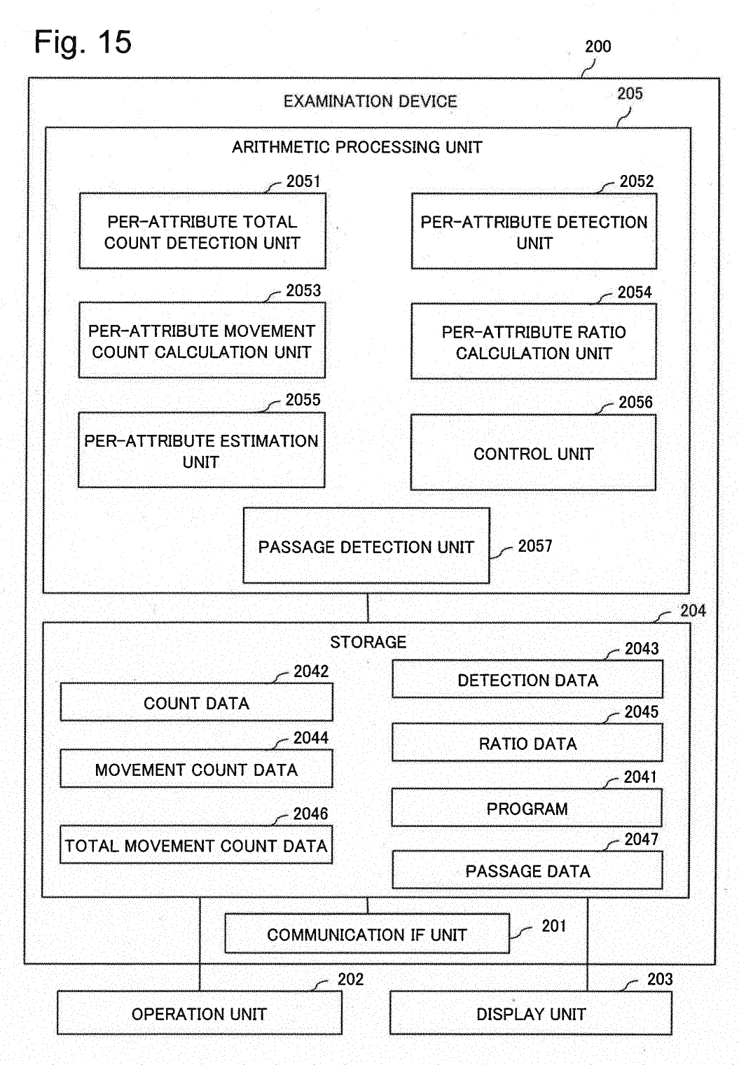

FIG. 15 is a block diagram of the examination device 200. Referring to FIG. 15, the examination device 200 includes a communication IF unit 201, a storage 204, and an arithmetic processing unit 205.

The communication IF unit 201 includes a dedicated data communication circuit and has a function of performing data communication with various types of devices connected through a wireless communication line, such as the passage detection device 280, the sensor 230, and the surveillance camera 240.

An operation unit 202 is composed of operation input devices such as a keyboard and a mouse and has a function of detecting an operation by an operator and outputting a signal in response to the operation to the arithmetic processing unit 205.

A display unit 203 includes a screen display device such as an LCD and has a function of displaying on a screen various types of information such as a per-attribute flow rate of person between areas 210, in response to an instruction from the arithmetic processing unit 205.

The storage 204 includes storage device such as a hard disk and a memory, and has a function of storing data and a program 2041 that are required for various types of processing in the arithmetic processing unit 205. The program 2041 is a program providing various types of processing units by being read and executed by the arithmetic processing unit 205. The program 2041 is acquired from an external device (unillustrated) or a storage medium (unillustrated) through a data input-output function such as the communication IF unit 201 and is saved in the storage 204. Further, main data stored in the storage unit 204 include count data 2042, detection data 2043, movement count data 2044, ratio data 2045, total movement count data 2046, and passage data 2047.

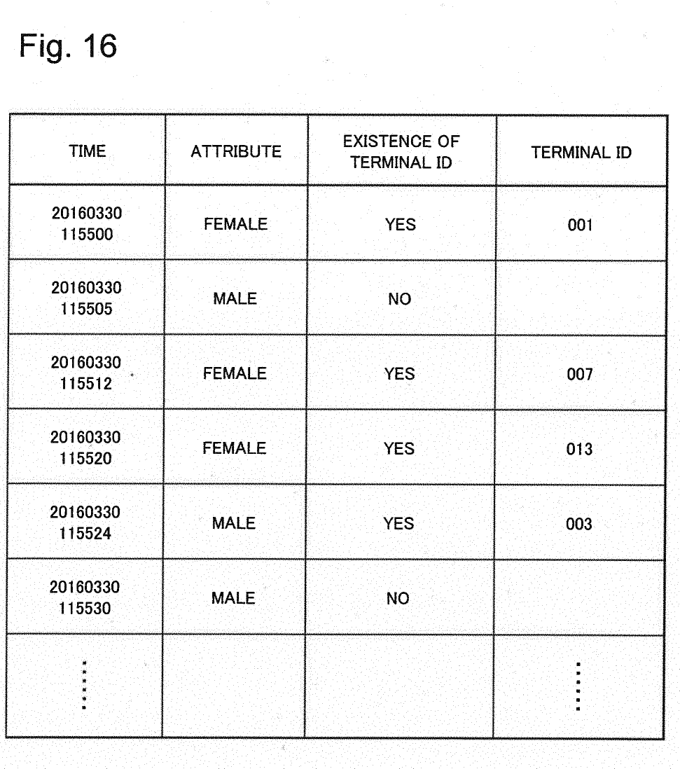

The passage data 2047 are information representing the attribute of the person 220 passing through the gate 270 and the terminal identification information that are detected by the passage detection device 280. FIG. 16 illustrates an example of the passage data 2047. The passage data 2047, in this example, are composed of a plurality of entries, and each entry is a combination of data associated with a time, an attribute, existence of the terminal ID, and the terminal ID. The time represents a time when the person 220 passes through the gate 270. The attribute represents an attribute of the person passing through the gate and represents either male or female, according to the second example embodiment. The existence of terminal ID represents whether the person passing through the gate carries the mobile terminal 250. The terminal ID is a terminal ID acquired from the mobile terminal 250 carried by the person passing through the gate 270. For example, the entry in the second row in FIG. 16 represents that the person 220 passing through the gate 270 at 11:55:00 AM on Mar. 30, 2016 is a female and carries the mobile terminal 250, and the terminal ID of the mobile terminal 250 is 001. Further, the entry in the third row in FIG. 16 represents that the person 220 passing through the gate 270 at 11:55:05 AM on Mar. 30, 2016 is a male and does not carry a mobile terminal.

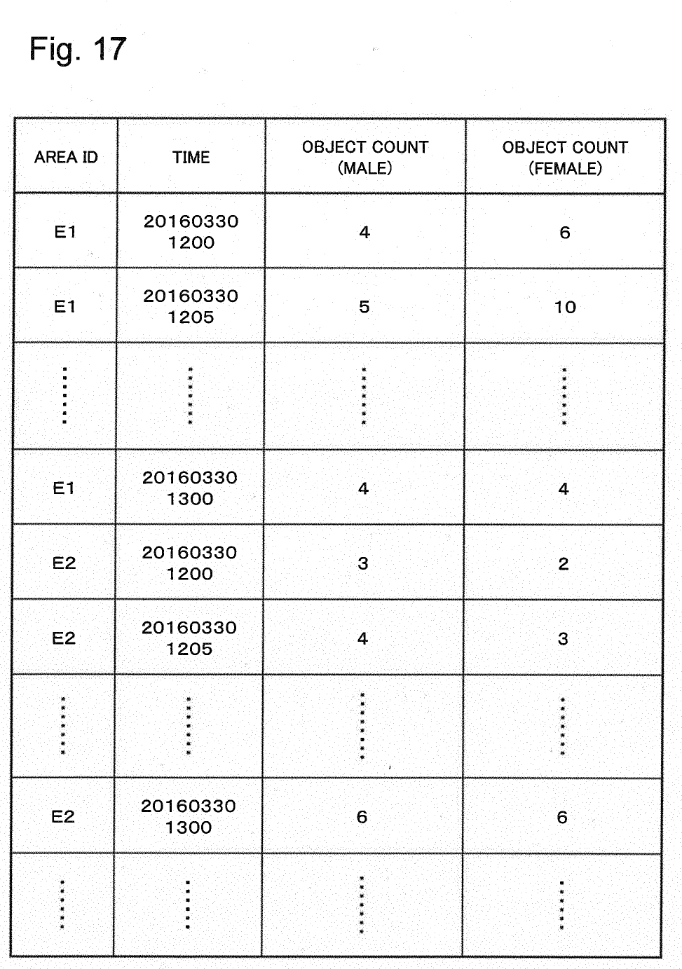

The count data 2042 are information representing the per-attribute number of persons 220 existing in the area 210, the number being detected by the surveillance camera 240. FIG. 17 illustrates an example of the count data 2042. The count data 2042 in this example are composed of a plurality of entries, and each entry is a combination of data associated with the area ID, a time, an the object count (male), and the object count (female). The area ID is identification information for identifying the area 210. The object count (male) and the object count (female) represent numbers of males and females existing in the area 210 specified by the area ID. The time represents a time when the object counts are detected. For example, the entry in the second row in FIG. 17 represents that four males and six females exist in the area 210 with the area ID E1 at a time point 12:00 on Mar. 30, 2016.

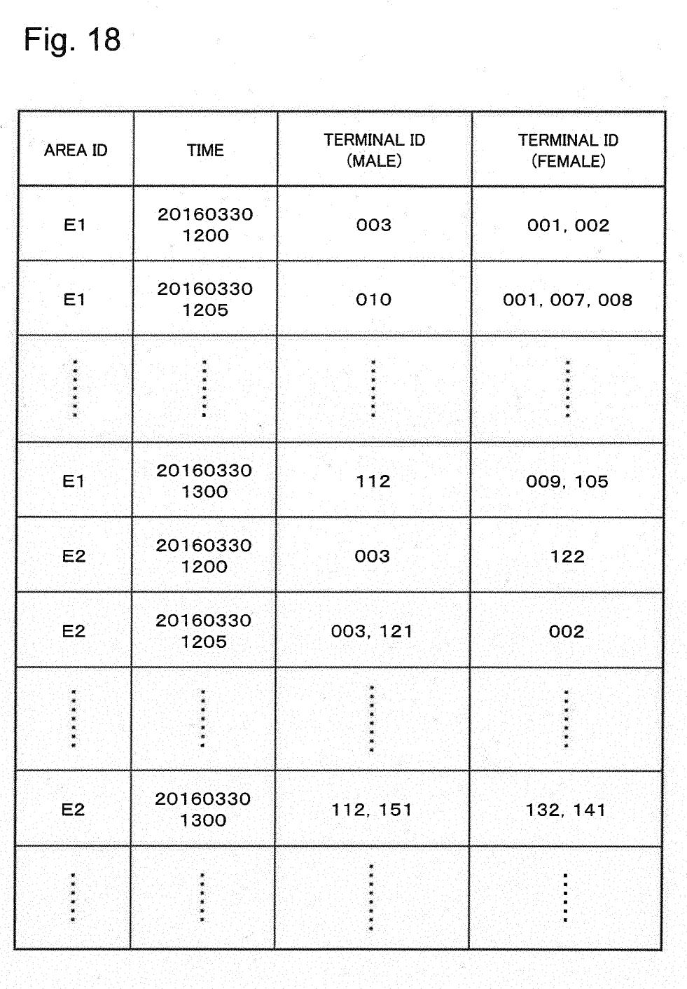

The detection data 2043 are information representing, by attribute, the terminal IDs of the mobile terminals 250 carried by person 220 existing in the area 210, the terminal IDs detected by the sensor 230. FIG. 18 illustrates an example of the detection data 2043. The detection data 2043 in this example are composed of a plurality of entries, and each entry is a combination of data associated with the area ID, a time, the terminal identification information (male), and the terminal identification information (female). The area ID is identification information for identifying an area 210. Each of the terminal ID (male) and the terminal ID (female) represents, by attribute, the terminal ID acquired from the mobile terminal 250 carried by the person 220 existing in a the area 210 specified by the area ID. The time represents a time when the terminal ID is detected. For example, the entry in the second row in FIG. 18 represents that one male carrying the mobile terminal 250 with the terminal ID “003” and two females carrying the mobile terminals 250 with terminal IDs “001” and “002” exist in the area 210 with the area ID E1 at a time point 12:00 on Mar. 30, 2016.

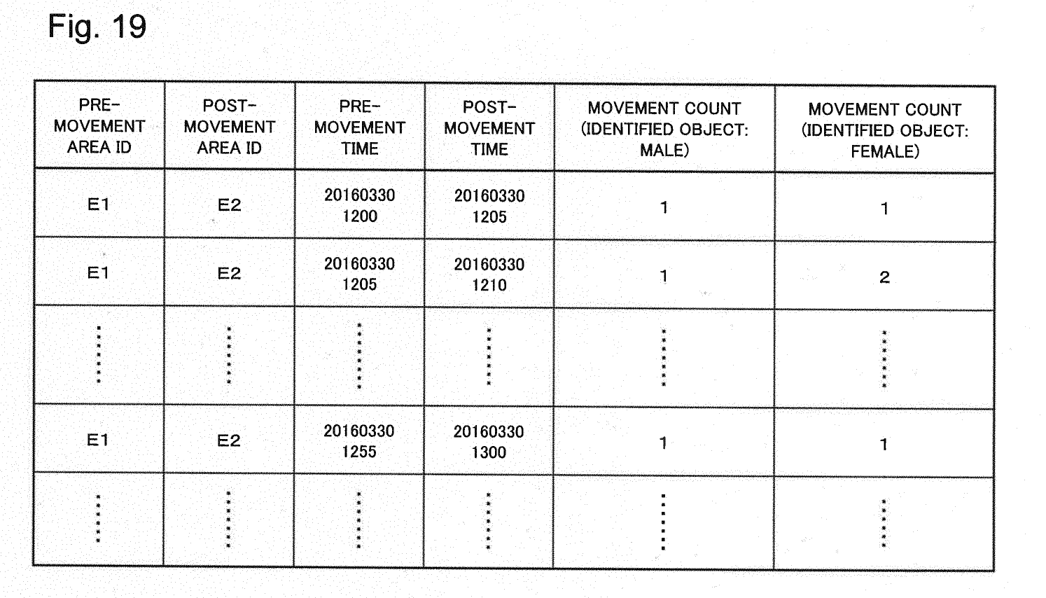

The movement count data 2044 are information representing, by attribute, the number of persons 220 moving between the areas 210 and also carrying the mobile terminals 250. FIG. 19 illustrates an example of the movement count data 2044. The movement count data 2044 in this example are composed of a plurality of entries, and each entry is a combination of data associated with the pre-movement area ID, the post-movement area ID, the pre-movement time, the post-movement time, the movement count (male), and the movement count (female). The pre-movement area ID and the post-movement area ID are the identification information for identifying the area 210 before movement and the area 210 after the movement. The pre-movement time and the post-movement time represent a time before the movement and a time after the movement, respectively. Each of the movement count (male) and the movement count (female) represents, by attribute, the number of persons 220 moving from the area 210 with the pre-movement area ID at the pre-movement time to the area 210 with the post-movement area ID at the post-movement time and also carrying the mobile terminals 250. For example, the entry in the second row in FIG. 19 represents that numbers of person 220 moving from the area 210 with the area ID E1 to the area 210 with the area ID E2 from 12:00 on Mar. 30, 2016 to 12:05 on the same day in the same year and also carrying the mobile terminals 250 are one male and one female.

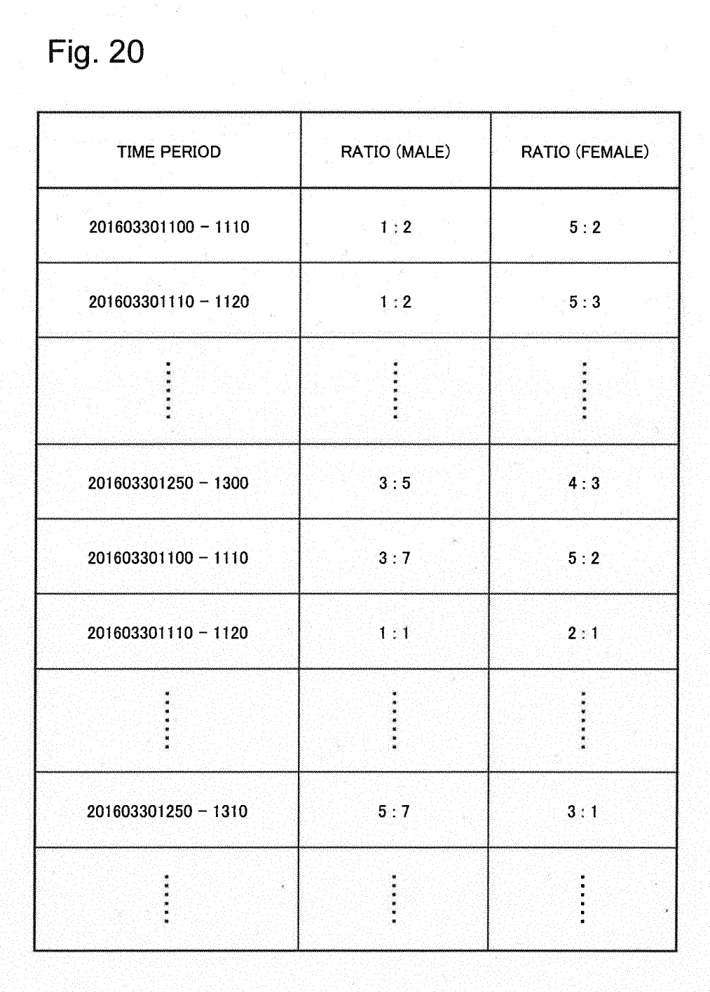

The ratio data 2045 are information representing, by attribute, the ratio between the number of persons (identified objects) 220 carrying the mobile terminals 250 and the number of persons (unidentified objects) 220 not carrying the mobile terminals 250. FIG. 20 illustrates an example of the ratio data 2045. The per-attribute ratio data 2045 in this example are composed of a plurality of entries, and each entry is a combination of data associated with a time period, a ratio (male), and a ratio (female). Each of the ratio (male) and the ratio (female) represents, by attribute, the ratio between the number of persons 220 passing through the gate 270 and also carrying the mobile terminals 250, and the number of persons 220 passing through the gate 270 and also not carrying the mobile terminals 250. The time period represents a time period in which the per-attribute ratios are calculated. For example, the entry in the second row in FIG. 20 represents that the ratios between the number of persons 220 passing through the gate 270 in 10 minutes between 11:00 and 11:10 on Mar. 30, 2016 and also carrying the mobile terminals 250, and the number of persons 220 passing through the gate 270 and not carrying the mobile terminals 250 are 1:2 for males and 5:2 for females.

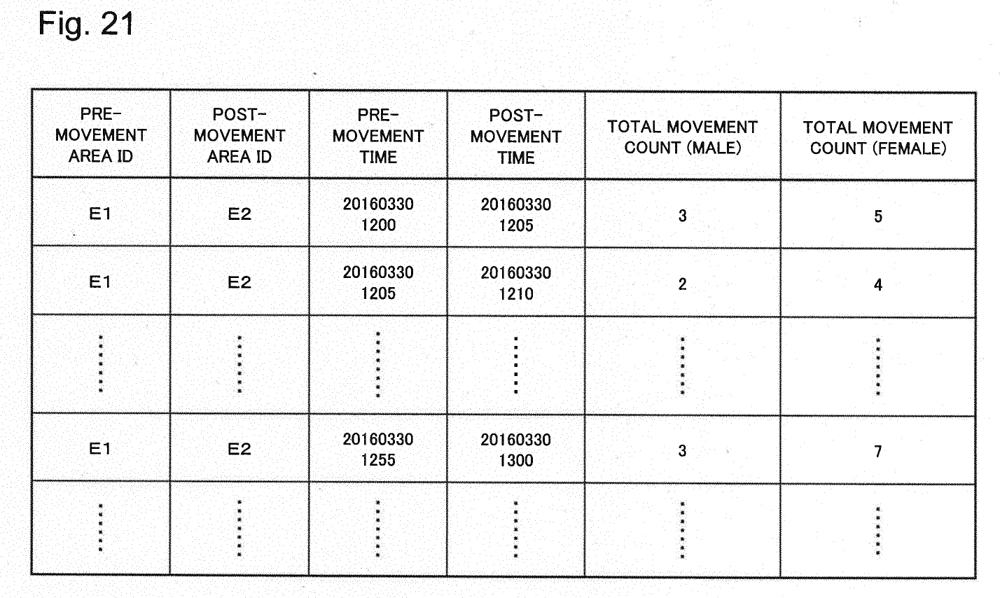

The total movement count data 2046 are information representing, by attribute, an estimated the number of persons 220 moving between the areas 210. FIG. 21 illustrates an example of the total movement count data 2046. The total movement count data 2046 in this example are composed of a plurality of entries, and each entry is a combination of data associated with the pre-movement area ID, the post-movement area ID, the pre-movement time, the post-movement time, the total movement count (male), and the total movement count (female). Meanings of the pre-movement area ID, the post-movement area ID, the pre-movement time, and the post-movement time are the same as those of the pre-movement area ID, the post-movement area ID, the pre-movement time, and the post-movement time in the movement count data 2044 illustrated in FIG. 19. Each of the total movement count (male) and the total movement count (female) represents, by attribute, the number of persons (persons carrying the mobile terminals 250 and persons not carrying the mobile terminals 250) 220 moving from the area 210 specified by the pre-movement area ID to the area 210 specified by the post-movement area ID from the pre-movement time to the post-movement time. For example, the entry in the second row in FIG. 21 represents that the number of persons 220 moving from the area 210 with the area ID E1 to the area 210 with the area ID E2 from 12:00 on Mar. 30, 2016 to 12:05 on the same day in the same year are three males and five females.

The arithmetic processing unit 205 includes a microprocessor such as a CPU and a peripheral circuit of the microprocessor, and has a function of providing various types of processing units by causing hardware and the program 2041 to cooperate with one another by reading the program 2041 from the storage 204 and executing the program. Main processing units provided by the arithmetic processing unit 205 include a per-attribute total count detection unit 2051, a per-attribute detection unit 2052, a per-attribute movement count calculation unit 2053, a per-attribute ratio calculation unit 2054, a per-attribute estimation unit 2055, a control unit 2056, and a passage detection unit 2057.

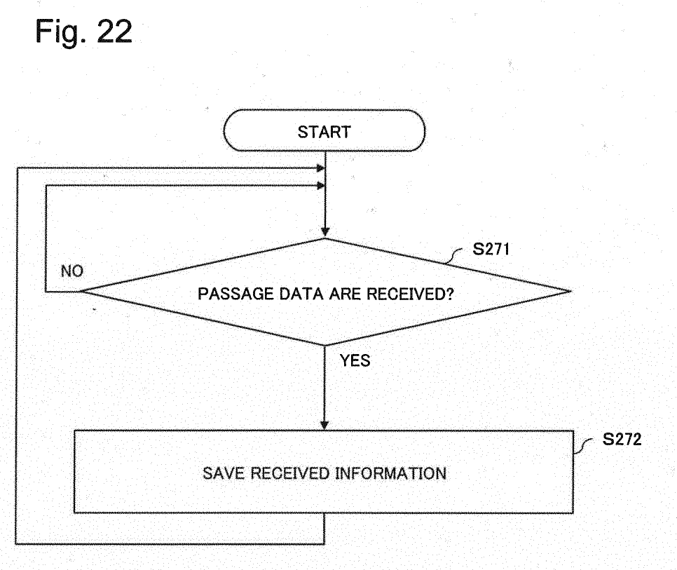

The passage detection unit 2057 has a function of receiving passage information transmitted from the passage detection device 280 and saving the information into the storage 204 as the passage data 2047. FIG. 22 is a flowchart illustrating an operation example of the passage detection unit 2057.

Referring to FIG. 22, when activated, the passage detection unit 2057 stands by until receiving passage data from the passage detection device 280 (S271). Thereafter, when receiving passage data, the passage detection unit 2057 adds to the passage data 2047 in the storage 204 an entry composed of a time, an attribute, existence of a terminal identification number, and the terminal ID that are included in the received passage data (S272). Then, the passage detection unit 2057 returns to Step S271 and stands by until receiving passage data from the passage detection device 280.

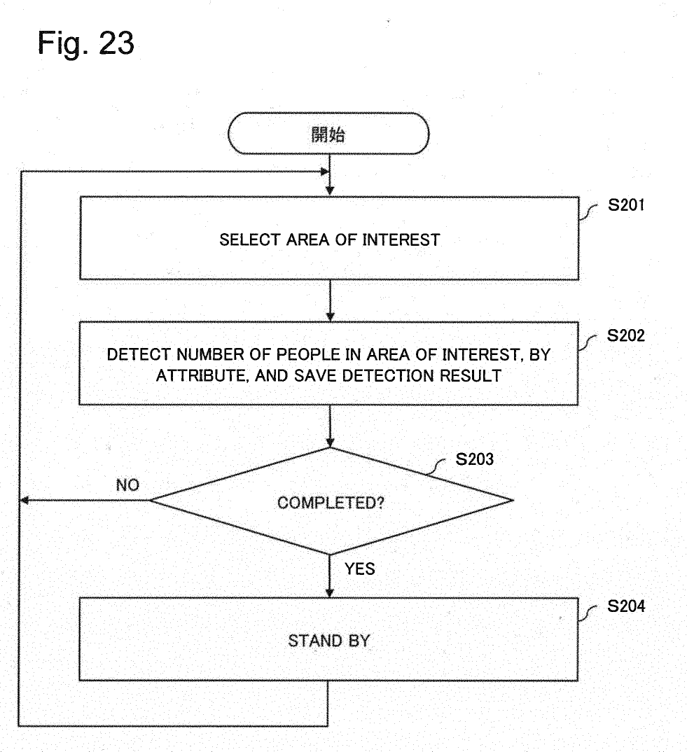

The per-attribute total count detection unit 2051 has a function of detecting the number of persons 220 existing in the area 210 by use of the surveillance camera 240 and saving the number into the storage 204 as the count data 2042. FIG. 23 is a flowchart illustrating an operation example of the per-attribute total count detection unit 2051.

Referring to FIG. 23, the per-attribute total count detection unit 2051 first focuses attention on the area 210 out of a plurality of areas 210 [selects the area of interest (S201)]. Subsequently, the per-attribute total count detection unit 2051 detects, by attribute, the number of persons 220 existing in the area of interest 210, by use of the surveillance camera 240 installed in the area 210. Then, the per-attribute total count detection unit 2051 adds to the count data 2042 a combination of data (entry) associated with the area ID of the area 210, the detection time, and the detected per-attribute numbers of persons (object counts) (S202). Thereafter, the per-attribute total count detection unit 2051 determines whether selection of every area 210 as the area of interest is completed (S203). Then, when the selection of every area 210 as the area of interest is not completed (NO in S203), the per-attribute total count detection unit 2051 returns to Step S201 in order to select a next area of interest and repeats processing similar to the processing in and after Step S201 described above. On the other hand, when focusing attention on every area 210 is completed (YES in S203), the per-attribute total count detection unit 2051 stands by for a set time (S204), and subsequently returns to Step S201 and performs processing similar to the processing described above from the beginning.

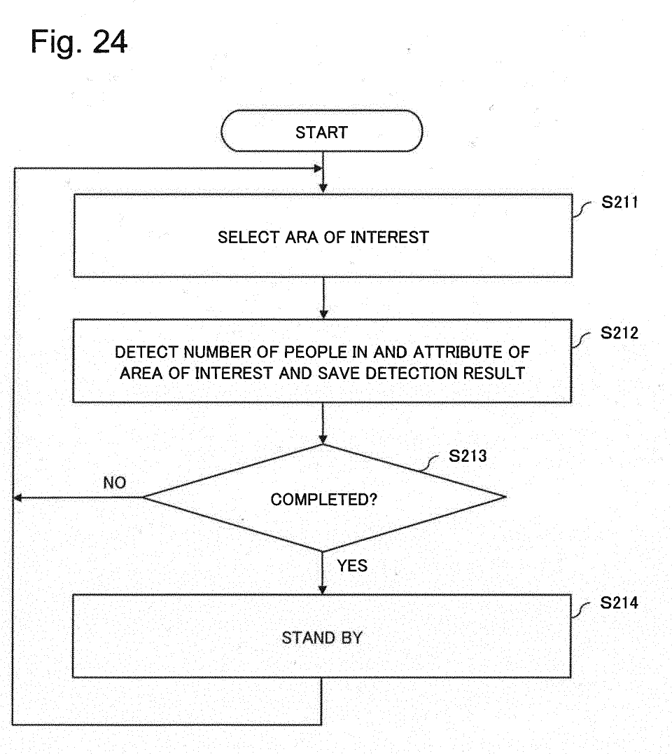

The per-attribute detection unit 2052 has a function of detecting the person 220 existing in the area 210 and also carrying the mobile terminal 250, by use of the passage data 2047 and the sensor 230, and saving the detection result into the storage 204 as the detection data 2043. FIG. 24 is a flowchart illustrating an operation example of the per-attribute detection unit 2052.

Referring to FIG. 24, the per-attribute detection unit 2052 first selects the area 210 out of all areas 210 as the area of interest (S211). Subsequently, the per-attribute detection unit 2052 detects the terminal ID of the mobile terminal 250 existing in the area of interest 210, by use of the sensor 230 installed in the area 210, and determines the attribute using the passage data 2047. Then, the per-attribute detection unit 2052 adds, to the detection data 2043, the area ID of the area 210, the detection time, the detected per-attribute terminal ID that are associated with one another (S212). In the attribute determination in Step 5212, the per-attribute detection unit 2052 searches the passage data 2047 for the entry having the terminal ID matching the terminal ID detected by use of the sensor 230 and sets the attribute included in the searched entry as the attribute to be determined. Subsequently, the per-attribute detection unit 2052 determines whether selection of every area 210 as the area of interest is completed (S213). Then, when the selection of every area 210 as the area of interest is not completed (NO in S213), the per-attribute detection unit 2052 returns to Step S211 in order to select the next area of interest and repeats processing similar to the processing in and after Step S211 described above. When the selection of every area 210 as the area of interest is completed (YES in S213), the per-attribute detection unit 2052 stands by for a set time (S214), and subsequently returns to Step S211 and performs processing similar to the processing described above from the beginning.

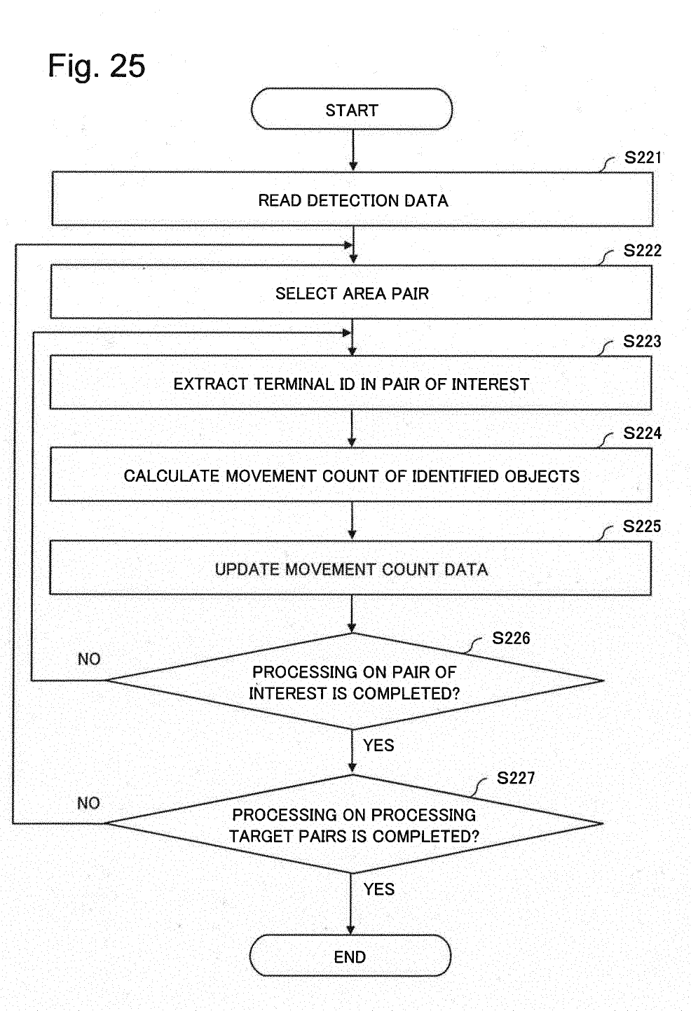

The per-attribute movement count calculation unit 2053 has a function of generating information representing, by attribute, the number of persons 220 moving between the areas 210 and also carrying the mobile terminals 250 using the detection data 2043 stored in the storage 204, and saving the information into the storage 204 as the movement count data 2044. FIG. 25 is a flowchart illustrating an operation example of the per-attribute movement count calculation unit 2053.

Referring to FIG. 25, the per-attribute movement count calculation unit 2053 first reads the detection data 2043 from the storage 204 (S221). Subsequently, the movement count calculation unit 2053 selects one area out of all areas 210 as the pre-movement area of interest and selects one area out of the other areas as the post-movement area of interest. In other words, the per-attribute movement count calculation unit 2053 selects a pair of the pre-movement area and the post-movement area (S222). When n areas 210 exist, the total count of area pairs becomes n×(n−1). The per-attribute movement count calculation unit 2053 may set the n×(n−1) pairs as the processing targets. Alternatively, the per-attribute movement count calculation unit 2053 may set pairs of adjacent areas as the processing targets. Information about pairs of adjacent areas may be previously given to the per-attribute movement count calculation unit 2053 or may be calculated by the per-attribute movement count calculation unit 2053 from positional information of areas or the like.

Subsequently, the per-attribute movement count calculation unit 2053 extracts the terminal IDs related to the pre-movement area of interest and the post-movement area of interest (S223). For example, the per-attribute movement count calculation unit 2053 extracts the terminal IDs associated with a time t in the pre-movement area of interest and the terminal IDs associated with a time t+Δt in the post-movement area of interest. Note that Δt is a predetermined time (e.g. 5 minutes). Then, the per-attribute movement count calculation unit 2053 extracts, by the attribute, the terminal IDs existing in common in the terminal IDs related to the pre-movement area of interest and the terminal IDs related to the post-movement area, and calculates, by attribute, the number of the extracted terminal IDs as the movement count of identified objects (S224). The per-attribute identified object count represents the per-attribute number of persons (identified objects) 220 moving from the pre-movement area of interest to the post-movement area of interest from the pre-movement time t to the post-movement time t+Δt. Subsequently, the per-attribute movement count calculation unit 2053 adds, to the movement count data 2044 in the storage 204, data (entry) associated with the area ID of the pre-movement area of interest 210, the area ID of the post-movement area of interest 210, the pre-movement time, the post-movement time, and the calculated per-attribute movement counts [i.e. updates the movement count data 1044 (S225)].

Subsequently, the per-attribute movement count calculation unit 2053 determines whether extraction of the terminal IDs and calculation of the movement count of identified objects are completed with respect to the pair of the pre-movement area of interest and the post-movement area of interest when the time is changed (S226). When the extraction and the calculation are not completed (NO in S226), the per-attribute movement count calculation unit 2053 returns to Step S223, changes the time t, and repeats processing similar to the processing described above. On the other hand, when the extraction and the calculation are completed (YES in S226), the per-attribute movement count calculation unit 2053 determines whether the movement count calculation processing is completed for every pair being the processing target (S227). When the processing is not completed (NO in S227), the per-attribute movement count calculation unit 2053 returns to Step S222 in order to select a next pair and repeats processing similar to the processing described above. When the movement count calculation processing is completed for every pair of areas being the processing target (YES in S227), the per-attribute movement count calculation unit 2053 ends the movement count calculation processing.

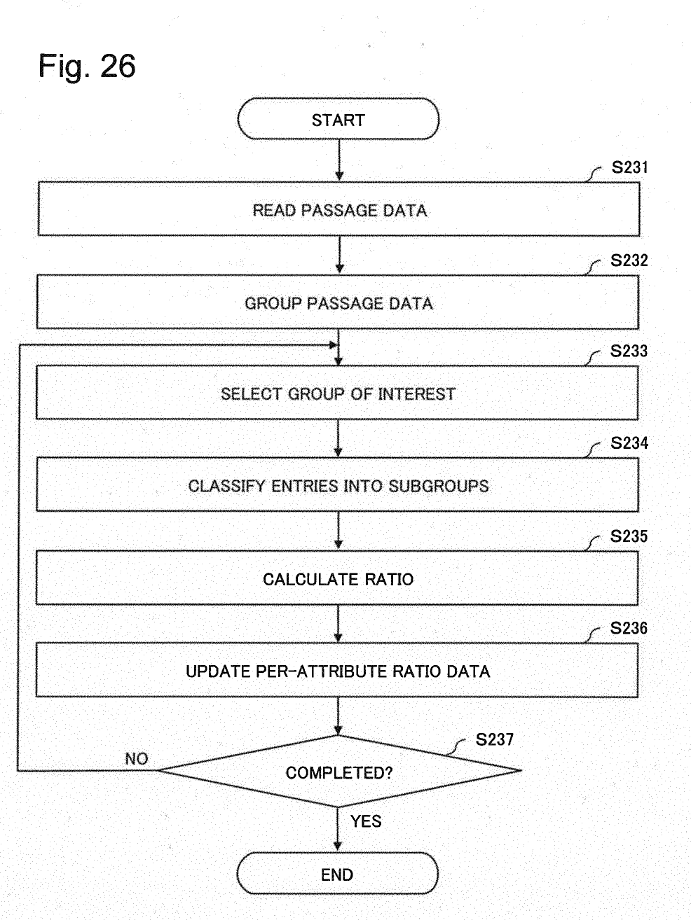

The per-attribute ratio calculation unit 2054 has a function of calculating the ratio between the number of persons 220 carrying the mobile terminals 250 and the number of persons 220 not carrying the mobile terminals 250 using the passage data 2047 stored in the storage 204. FIG. 26 is a flowchart illustrating an operation example of the per-attribute ratio calculation unit 2054.

Referring to FIG. 26, the per-attribute ratio calculation unit 2054 first reads the passage data 2047 from the storage 204 (S231). Then, the per-attribute ratio calculation unit 2054 classifies entries in the passage data 2047 into groups by time period using the times in the entries (S232). For example, the time periods may be set as time periods from every hour sharp at 10-minute intervals but are not limited to such time periods. Subsequently, the per-attribute ratio calculation unit 2054 focuses attention on one group (S233). Then, the per-attribute ratio calculation unit 2054 classifies entries included in the group of interest into per-attribute subgroups (S234). In this example, the attribute is sex, and therefore entries are classified into a male subgroup and a female subgroup. Subsequently, for each subgroup in the group of interest, the per-attribute ratio calculation unit 2054 calculates a ratio between a number of entries with terminal IDs and a number of entries without the terminal IDs as a ratio related to the attribute of the subgroup (S235). For example, when there are 10 entries in total in the male subgroup in the group of interest, and three of the 10 entries have the terminal IDs and the remaining seven entries do not have the terminal IDs, the per-attribute ratio calculation unit 2054 calculates the ratio between the number of males carrying the mobile terminals 250 and the number of males not carrying the mobile terminals 250 to be 3:7.

Thereafter, the per-attribute ratio calculation unit 2054 adds, to the per-attribute ratio data 2045 in the storage 204, data associated with a time period of the group of interest and the calculated per-attribute ratio (S236). Subsequently, the per-attribute ratio calculation unit 2054 determines whether selection of every group is completed (S237). Then, when an unselected group exists (NO in S237), the per-attribute ratio calculation unit 2054 returns to Step S233 and repeats processing similar to the processing described above. On the other hand, when the selection of every group is completed (YES in S237), the attribute ratio calculation unit 2054 ends the ratio calculation processing.

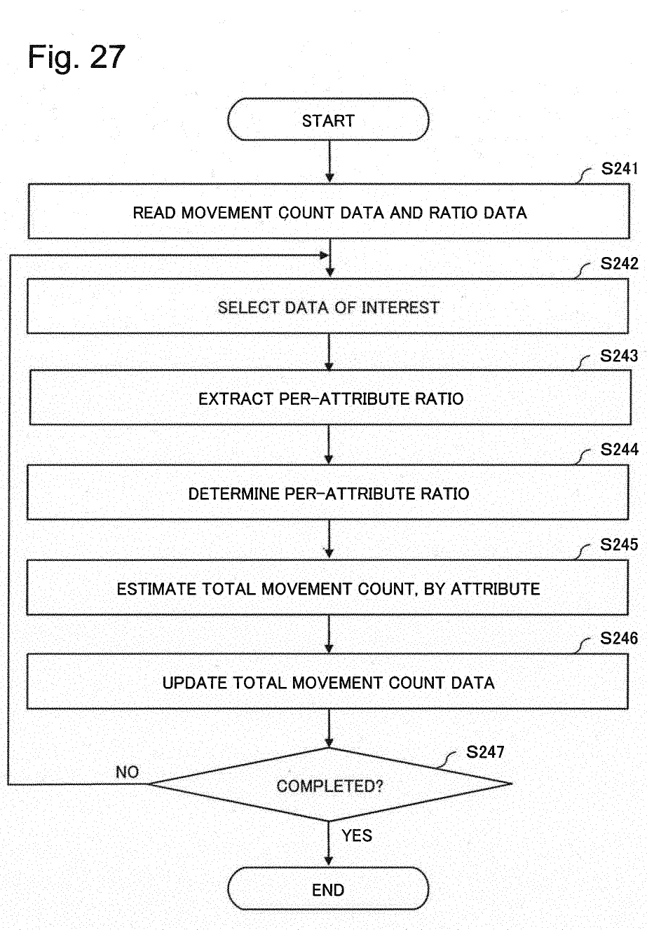

The per-attribute estimation unit 2055 has a function of calculating, by the attribute, the flow rate of person 220 moving between the areas 210 using the movement count data 2044 and the ratio data 2045 that are stored in the storage 204, and saving the calculation result into the storage 204. FIG. 27 is a flowchart illustrating an operation example of the per-attribute estimation unit 2055.

Referring to FIG. 27, the per-attribute estimation unit 2055 first reads the movement count data 2044 and the ratio data 2045 from the storage 204 (S241). Subsequently, the per-attribute estimation unit 2055 selects the entry in the movement count data 2044 as data of interest (S242). Then, the per-attribute estimation unit 2055 extracts the ratio from the ratio data 2045 using the pre-movement time and the post-movement time in the data of interest (S243). For example, since it is physically impossible for the person 220 passing through the gate 270 after the post-movement time to move between the areas of interest, the per-attribute estimation unit 2055 determines as the entry to be used the entry other than the entry including a time period later than the post-movement time in the ratio data 2045. Alternatively, taking into consideration an average time for which the same person 220 stays in the same area 210, the per-attribute estimation unit 2055 may calculate a time derived by subtracting the aforementioned average time from the pre-movement time or the post-movement time, and determine as the entry to be used the entry including a time period at least part of which is included in a time period from the calculated time to the post-movement time. However, without being limited to such an example, the per-attribute estimation unit 2055 may determine as the entry to be used the entry including a specific time period or every entry in the ratio data 2045.

Subsequently, the per-attribute estimation unit 2055 determines the per-attribute ratio to be used using the per-attribute ratio included in the entry determined to be the entry to be used in the ratio data 2045 (S244). For example, when there is one entry determined to be the entry to be used in the ratio data 2045, the per-attribute estimation unit 2055 determines the per-attribute ratio included in the entry as the ratio to be used. Further, when there are a plurality of entries determined to be entries to be used, the per-attribute estimation unit 2055 calculates, for example, an average value, a maximum value, or a minimum value of ratios included in the plurality of entries and determines the calculated value to be a ratio to be used.

Subsequently, the per-attribute estimation unit 2055 calculates, by the attribute, the total movement count being the number of moving persons by the following equation using the object count (movement count) included in the entry in the movement count data 2044 of interest and the determined per-attribute ratio described above (S245).

total movement count of attribute i=object count of attribute i×(xi+yi)/xi (2)

Note that xi:yi denotes the ratio between the number of persons with the attribute i carrying the mobile terminals 250 and the number of persons with the attribute i not carrying the mobile terminals 250.

For example, when a number of moving males included in the entry in the movement count data 2044 of interest is “3,” and the ratio xi:yi to be used is 3:7, the per-attribute estimation unit 2055 estimates the total count of moving males to be 3×(3+7)/3=10.

Then, the per-attribute estimation unit 2055 adds, to the total movement count data 2046 in the storage 204, the pre-movement area ID, the post-movement area ID, the pre-movement time, and the post-movement time of the data of interest, and the calculated per-attribute total movement counts described above [updates the total movement count data 2046 (S246)]. Then, the per-attribute estimation unit 2055 determines whether data (entry) related to the pre-movement area ID, the post-movement area ID, the pre-movement time, and the post-movement time that are not used in the estimation of the total movement count exist in the movement count data 2044 (i.e. whether the total movement count estimation processing is completed) (S247). When the processing is not completed (NO in S247), the per-attribute estimation unit 2055 returns to Step S242 and repeats processing similar to the processing described above. On the other hand, when the total movement count estimation processing is completed (YES in S247), the per-attribute estimation unit 2055 ends the total movement count estimation processing.

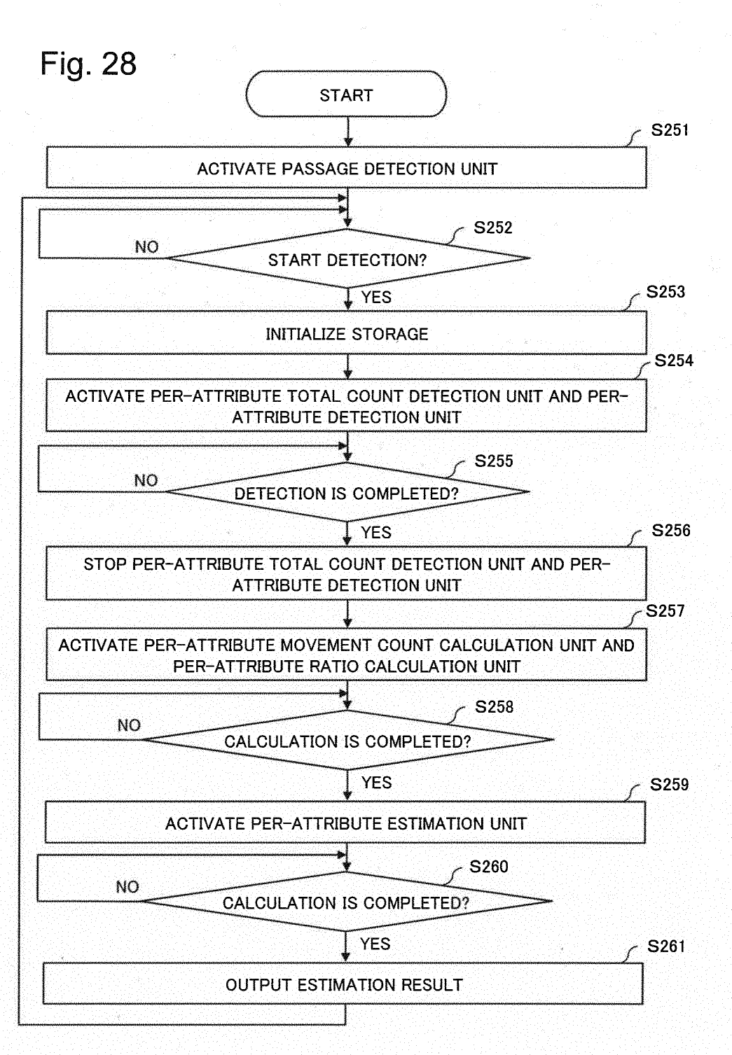

The control unit 2056 has a function of controlling the entire examination device 200. FIG. 28 is a flowchart illustrating an operation example of the control unit 2056. The entire operation of the examination device 200 will be described below with reference to FIG. 28.

Referring to FIG. 28, the control unit 2056 first activates the passage detection unit 2057 (S251).

The activated passage detection unit 2057 starts the operation described with reference to FIG. 22, receives information about the object passing through the gate 270, the information transmitted from the passage detection device 280, and saves the information into the storage 204 as the passage data 2047 as illustrated in FIG. 16.

Then, the control unit 2056 stands by in preparation for input of the instruction to start detection from a user through the operation unit 202 (S252). When the instruction to start the detection is input, the control unit 2056 first initializes the storage 204 (S253). Consequently, the count data 2042, the detection data 2043, the movement count data 2044, the ratio data 2045, and the total movement count data 2046, other than the passage data 2047, are initialized. Subsequently, the control unit 2056 activates the per-attribute total count detection unit 2051 and the detection unit 2052 (S254). Then, the control unit 2056 stands by in preparation for input of an instruction to end the detection from the user through the operation unit 202 (S255).

On the other hand, the activated per-attribute total count detection unit 2051 starts the operation described with reference to FIG. 23, detects the number of persons 220 existing in the area 210 by use of the surveillance camera 240, and saves the number into the storage 204 as the count data 2042 as illustrated in FIG. 17. Further, the activated detection unit 2052 starts the operation described with reference to FIG. 24, detects the person (identified object) 220 existing in the area 210 and also carrying the mobile terminal 250, by use of the passage data 2047 and the sensor 230, and saves the detection result into the storage 204 as the detection data 2043 as illustrated in FIG. 18.

Subsequently, when the instruction to end the detection is input, the control unit 2056 stops the per-attribute total count detection unit 2051 and the per-attribute detection unit 2052 (S256). Consequently, the per-attribute total count detection unit 2051 stops the operation described with reference to FIG. 23, and the per-attribute detection unit 2052 stops the operation described with reference to FIG. 24. Subsequently, the control unit 2056 activates the per-attribute movement count calculation unit 2053 and the per-attribute ratio calculation unit 2054 (S257). Then, the control unit 2056 stands by until the operations are completed (S258).

On the other hand, the activated per-attribute movement count calculation unit 2053 starts the operation described with reference to FIG. 25, generates information representing, by the attribute, the number of persons 220 moving between the areas 210 and also carrying the mobile terminals 250 using the detection data 2043 as illustrated in FIG. 18, and saves the movement count data 2044 as illustrated in FIG. 19 into the storage 204. Further, the per-attribute ratio calculation unit 2054 starts the operation described with reference to FIG. 26 and calculates the per-attribute ratio between the number of persons (identified objects) 220 carrying the mobile terminals 250 and the number of persons (unidentified objects) 220 not carrying the mobile terminals 250 using the passage data 2047 as illustrated in FIG. 16. Then, the per-attribute ratio calculation unit 2054 saves the ratio data 2045 as illustrated in FIG. 20 into the storage 204.

Subsequently, when detecting completion of the operations of the per-attribute movement count calculation unit 2053 and the per-attribute ratio calculation unit 2054, the control unit 2056 activates the per-attribute estimation unit 2055 (S259). Then, the control unit 2056 stands by until the operation of the per-attribute estimation unit 2055 is completed (S260).

On the other hand, the activated per-attribute estimation unit 2055 starts the operation described with reference to FIG. 27, estimates the flow rate of person 220 moving between the areas 210 using the movement count data 2044 as illustrated in FIG. 19 and the ratio data 2045 as illustrated in FIG. 20, and saves the total movement count data 2046 as illustrated in FIG. 21 into the storage 204.

Subsequently, when detecting completion of the operation of the per-attribute estimation unit 2055, the control unit 2056 reads the total movement count data 2046 from the storage 204, transmits the data to an external terminal through the communication IF unit 201, and also displays the estimation result on the display unit 203 (S261). Then, the control unit 2056 returns to Step S252 and stands by until the instruction to start the detection is input from a user through the operation unit 202.

Thus, the examination device 200 according to the second example embodiment can examine the flow of person (flow rate) by the attribute when person 220 moving between the areas 210 and also carrying the mobile terminal 250, and person 220 not carrying the mobile terminal 250 coexist.

The reason is that the per-attribute detection unit 2052 periodically detects, by the attribute, the terminal IDs of mobile terminals 250 carried by persons 220 existing in each area 210, and based on the result of the detection described above, the per-attribute movement count calculation unit 2053 calculates, by the attribute, the number of persons moving between the areas 210 and also carrying the mobile terminals 250. Then, based on the calculated per-attribute number of persons carrying the mobile terminals 250 described above and the per-attribute ratio between the number of persons 220 carrying the mobile terminals and the number of persons 220 not carrying the mobile terminals, the per-attribute estimation unit 2055 estimates the per-attribute total count of person 220 moving between the areas 210 and also carrying the mobile terminal 250, and person 220 moving between the areas 210 and also not carrying the mobile terminal 250. The estimation is based on an empirical rule that behaviors of many persons having the same attribute can be roughly inferred by behaviors of part of the persons.

Further, the examination device 200 according to the second example embodiment takes an attribute into consideration and therefore can more accurately calculate a number of objects moving between the areas, compared with the examination device 100 according to the first example embodiment. A specific example will be described below.

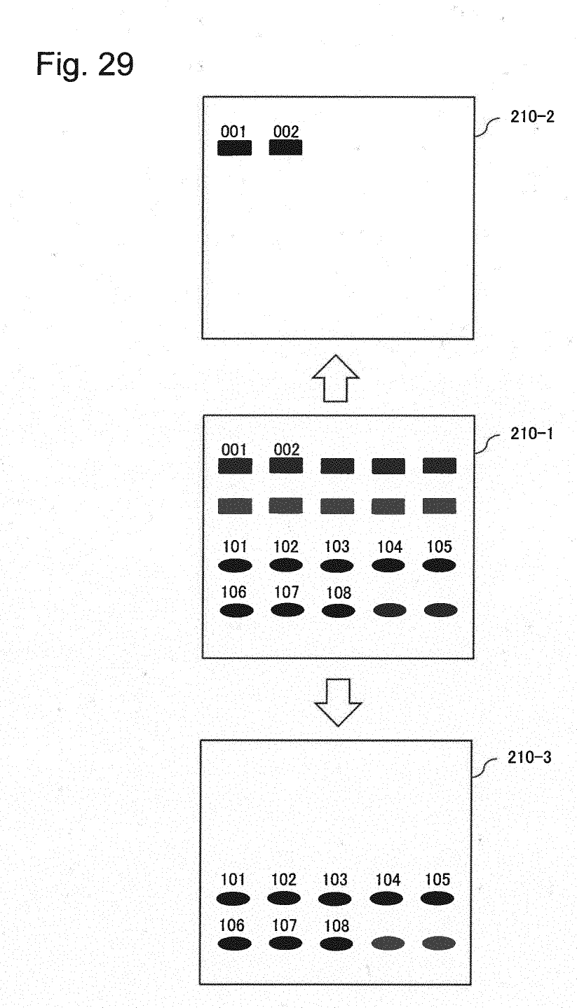

Three areas 210-1, 210-2, and 210-3 as illustrated in FIG. 29 are assumed here. It is assumed that 10 males and 10 females exist in the area 210-1, and no one exists in the remaining areas 210-2 and 210-3, at an initial time point. It is further assumed that two out of the 10 males carry the mobile terminals 250 and the terminal IDs thereof are “001” and “002.” It is further assumed that eight out of the 10 females carry mobile terminals 250, and the terminal IDs thereof are “101” to “108.” At this time, the ratios between the number of persons 220 carrying the mobile terminals 250 and the number of persons 220 not carrying the mobile terminals 250 are 1:4 for males and 4:1 for females.

Subsequently, it is assumed that, at a time point when a predetermined time elapses, the terminal IDs “001” and “002” held by the males are detected in the area 210-2, the terminal identification information “101” to “108” held by the females is detected in the area 210-3, and no terminal identification information is detected at all in the area 210-1. For example, such a situation that areas to move to differ between males and females is found when the area 210-2 is a facility frequently visited by males, the area 210-3 is a facility frequently visited by females, and the area 210-1 is a pathway or the like between the two facilities.

In the situation described above, numbers of males and females moving from the area 210-1 to the area 210-2 are calculated to be 10 and zero, respectively, and numbers of males and females moving from the area 210-1 to the area 210-3 are calculated to be zero and 10, respectively, in accordance with equation (2) described above, according to the second example embodiment. On the other hand, according to the first example embodiment not taking the attribute into consideration, the ratio of the number of persons carrying the mobile terminals and the number of persons not carrying the mobile terminals becomes 1:1, and the number of persons moving from the area 210-1 to the area 210-2 is calculated to be four, and the number of persons moving from the area 210-1 to the area 210-3 is calculated to be 16, in accordance with equation (1) described above.

While the passage detection device 280 detects the attribute of the person 220 passing through the gate 270, by use of the surveillance camera 282 in the description of the second example embodiment, the attribute may be detected by another method. For example, the passage detection device 280 may detect the attribute of the person passing through the gate 270 using the attribute information reported in real time from an examiner terminal placed on the gate 270. The examiner terminal is a wireless terminal operated by an examiner (person) and, for example, is configured to transmit the attribute determined by the examiner himself/herself to the passage detection device 280 by wireless communication.

Further, the per-attribute total count detection unit 2051 detects, by the attribute, the number of persons 220 existing in the area 210, by use of the surveillance camera 240. However, the per-attribute total count detection unit 2051 may detect, by the attribute, the number of persons 220 existing in the area 210, by use of a means other than the surveillance camera 240. For example, the per-attribute total count detection unit 2051 may detect, by the attribute, the number of persons 220 existing in the area 210 using information about the per-attribute number of persons reported in real time from the examiner terminal placed in each area 210. The examiner terminal is a wireless terminal operated by the examiner (person) and, for example, is configured to transmit the per-attribute number of persons counted by the examiner himself/herself to the per-attribute total count detection unit 2051 by wireless communication.

Further, the per-attribute detection unit 2052 identifies whether the person 220 is an individually identifiable object by the terminal ID included in the wireless LAN frame transmitted from the mobile terminal 250. However, the method of detecting whether the person 220 is an individually identifiable object is not limited to the above and may be another method. For example, the per-attribute detection unit 2052 may detect whether the person 220 is an individually identifiable object by detecting the terminal identification information transmitted from the wireless terminal other than the mobile terminal carried by the person 220. Alternatively, the per-attribute detection unit 2052 may detect whether the person 220 is an individually identifiable object (i.e. a preregistered person) by analyzing a facial image acquired through capturing by a camera.

Further, while the per-attribute ratio calculation unit 2054 calculates the ratio for each passage time period and attribute using whether the terminal identification information of the object passing through the gate 270 exists and the attribute of the object, the unit may be configured to calculate the per-attribute ratio over the entire passage time. Alternatively, the per-attribute ratio calculation unit 2054 may be omitted, and the predetermined per-attribute ratio may be used in a fixed manner.

Further, while the object is a person according to the second example embodiment, the object is not limited to a person and may be a vehicle, an animal, or the like. In a case of the vehicle, for example, the per-attribute detection unit 2052 may detect whether the vehicle is an individually identifiable object by detecting the terminal identification information from the wireless frame transmitted from the wireless terminal equipped on the vehicle. Then, for example, an automobile type such as a large-sized automobile or a small-sized automobile, an automobile manufacturer, an automobile model name, and the like are considered as attributes of the vehicle. For example, the per-attribute detection unit 2052 may extract a feature of the vehicle from an image of the vehicle acquired through capturing by the surveillance camera and detect the attribute of the vehicle using the vehicle feature. Further, in a case of the animal, for example, the per-attribute detection unit 2052 may detect whether the animal is an individually identifiable object by detecting the terminal identification information from the wireless frame transmitted from the wireless terminal attached to the animal. Then, for example, a kind of animal, sex, and the like are considered as attributes of the animal. For example, the per-attribute detection unit 2052 may extract a feature of the animal from an image of the animal acquired through capturing by the surveillance camera and detect the attribute of the animal using the animal feature.

### Third Example Embodiment

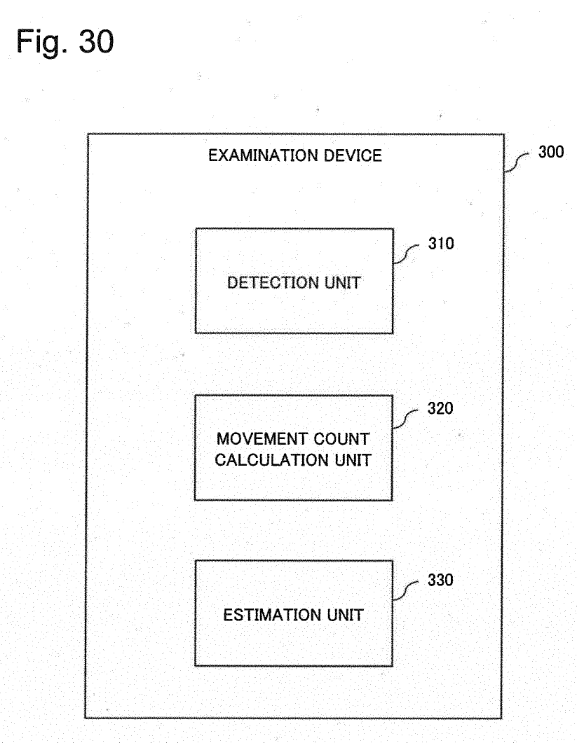

Referring to FIG. 30, an examination device 300 according to a third example embodiment of the present invention includes a detection unit 310, a movement count calculation unit 320, and an estimation unit 330.

The detection unit 310 has a function of detecting an identified object in each area of a first area and a second area where individually identifiable identified objects and unidentified objects individual identification of which is difficult coexist.

The movement count calculation unit 320 has a function of calculating the number of identified objects moving from the first area to the second area using a detection result by the detection unit 310.

The total movement count calculation unit 330 has a function of calculating a total movement count of identified objects and unidentified objects that move from the first area to the second area using a movement count of identified objects calculated by the movement count calculation unit 320 and a ratio between the number of identified objects and the number of unidentified objects for each area.

The thus configured examination device 300 according to the third example embodiment functions as follows. Specifically, first, the detection unit 310 detects the identified object existing in each area of the first area and the second area where individually identifiable identified objects and unidentified objects individual identification of which is difficult coexist. Next, based on the detection result by the detection unit 310, the movement count calculation unit 320 calculates the movement count of identified objects moving from the first area to the second area. Next, based on the calculated movement count of identified objects and the ratio between the number of identified objects and the number of unidentified objects for each area, the total movement count calculation unit 330 calculates the total movement count of identified objects and the unidentified objects that move from the first area to the second area.

Thus, the examination device 300 according to the third example embodiment can examine a flow rate of objects when an individually identifiable identified object and an unidentified object individual identification of which is difficult coexist.

The reason is as follows. Specifically, the detection unit 310 detects the identified object existing in each area of the first area and the second area where identified objects and unidentified objects coexist, according to the third example embodiment. Then, based on the detection result by the detection unit 310, the movement count calculation unit 320 calculates the movement count of identified objects moving from the first area to the second area. Additionally, based on the calculated movement count of identified objects described above and the ratio between the number of identified objects and the number of unidentified objects for each area, the total movement count calculation unit 330 calculates the total movement count of identified objects and unidentified objects that move from the first area to the second area. Consequently, the examination device 300 according to the third example embodiment can examine the flow rate of objects even when identified object and unidentified object coexist.

While the present invention has been described above with reference to several example embodiments, the present invention is not limited to the aforementioned example embodiments only, and various other additions and changes are possible.

For example, the ratio calculation unit 1054 according to the first example embodiment calculates the ratio between the number of persons carrying the mobile terminals 150 and the number of persons not carrying the mobile terminals 150 using the count data 1042 and the detection data. Instead, for example, whether an object is the identified object or the unidentified object may be detected for each object passing through a gate, by use of the passage detection device 280 illustrated in FIG. 14. Then, based on the number of detected identified objects and the number of detected unidentified objects, the aforementioned ratio may be calculated.

Further, the per-attribute ratio calculation unit 2054 according to the second example embodiment calculates, by the attribute, the ratio between the number of persons carrying the mobile terminals 250 and the number of persons not carrying the mobile terminals 250 using the passage data related to the object passing through the gate. Instead, the per-attribute ratio calculation unit 2054 may calculate, by the attribute, the ratio between the number of persons carrying the mobile terminals 250 and the number of persons not carrying the mobile terminals 250 using the count data 2042 illustrated in FIG. 17 and the detection data 2043 illustrated in FIG. 18. The operation of the per-attribute ratio calculation unit 2054 at this time becomes an operation of executing, for each attribute, the operation in FIG. 11 illustrating the operation of the ratio calculation unit 1054.

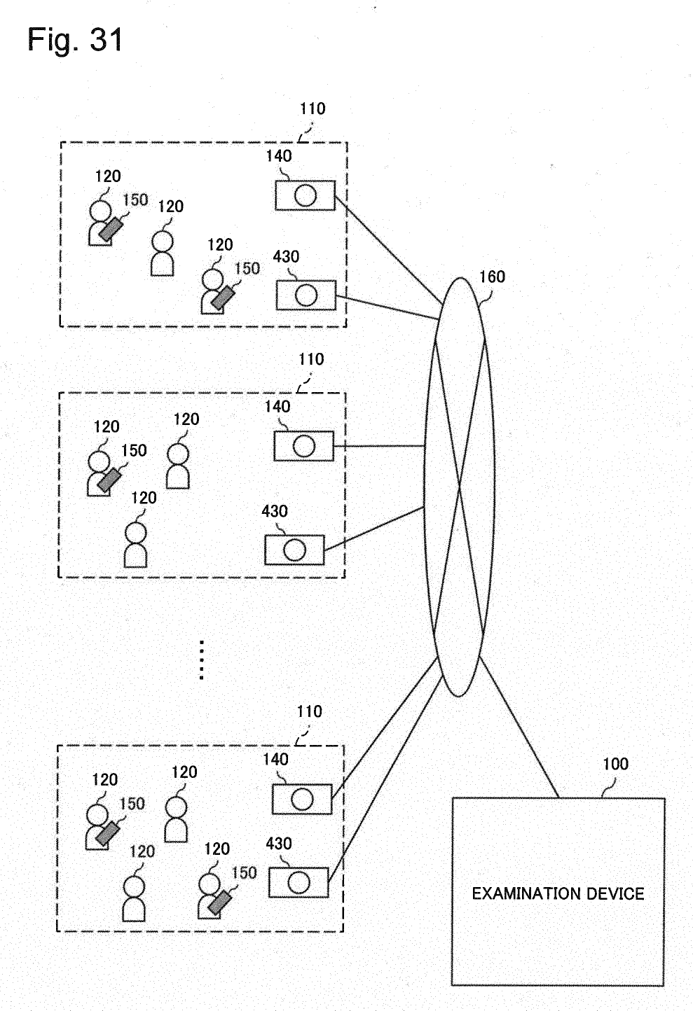

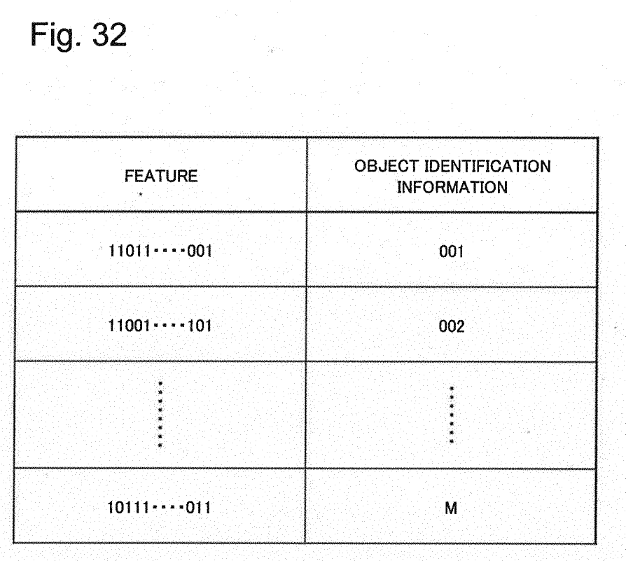

Further, as illustrated in FIG. 31, an authentication camera 430 detecting whether the person 120 is the individually identifiable object by individual authentication (e.g. face authentication) may be used in place of the sensor 130, according to the example embodiment illustrated in FIG. 1. The authentication camera 430 extracts the facial feature from the facial image of the person acquired through capturing inside the area 110, and using the facial feature, detects whether the person is a preregistered person. FIG. 32 illustrates an example of an authentication table used by the authentication camera 430. The authentication table in this example is composed of a plurality of entries, and each entry is a combination of data associated with a feature and object identification information. The feature is a preregistered facial feature of a person, and the object identification information is a number for identifying the person and the like.

The authentication camera 430 searches the authentication table for the feature matching the facial feature extracted from the facial image of the person acquired through capturing inside the area 110. When the feature matching the facial feature exists, the authentication camera 430 determines that the person 120 is the individually identifiable identified object and transmits the object detection result including the object identifier related to the matching feature and identification information of the area 110 to the detection unit 1052 in the examination device 100 through the wireless network 160. The object identifier included in the aforementioned object detection result is used in place of a terminal ID according to the example embodiment illustrated in FIG. 1, in the processing by the examination device 100.

The surveillance camera 140 and the authentication camera 430 for each area 110 in FIG. 31 may be replaced with a single camera combining functions of the cameras.

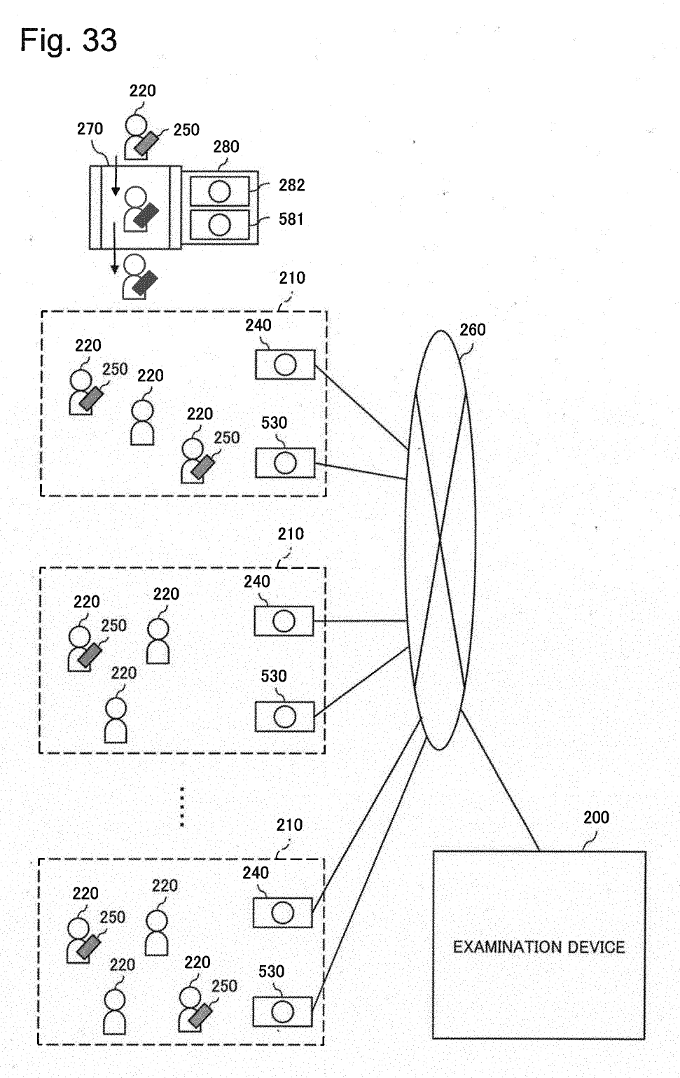

Further, as illustrated in FIG. 33, authentication cameras 581 and 530 detecting whether or not a person 220 is an individually identifiable identified object by individual authentication (e.g. face authentication) may be used in place of sensors 281 and 230, according to the example embodiment illustrated in FIG. 14. The authentication camera 581 extracts the facial feature from the facial image of the person acquired through capturing the person 220 passing through the gate 270, and based on the facial feature, detects which of preregistered person matches the person. Further, the authentication camera 581 extracts the facial feature from the facial image of a person acquired through capturing inside the area 210, and based on the facial feature, detects which of preregistered person matches the person. An authentication table used by the authentication cameras 581 and 530 may be the same as the one illustrated in FIG. 32.

The authentication camera 581 searches the authentication table for the feature matching the facial feature extracted from the facial image of a person acquired through capturing the person 220 passing through the gate 270. When the feature matching the facial feature exists, the authentication camera 581 determines the person 220 to be the individually identifiable identified object and notifies the passage detection device 280 of an object identifier related to the matching feature. The passage detection device 280 uses the notified object identifier in place of the terminal ID according to the example embodiment illustrated in FIG. 14. Accordingly, for example, “existence of object identification information” and “object identification information” are recorded in place of “existence of a terminal ID” and a “terminal ID” in the passage data 2047 in FIG. 16.

The authentication camera 530 searches the authentication table for the feature matching the facial feature extracted from the facial image of a person acquired through capturing inside the area 210. When the feature matching the facial feature exists, the authentication camera 530 determines the person 220 to be the individually identifiable identified object and transmits the detection result including the object identifier related to the matching feature and identification information of the area 110 to the detection unit 2052 in the examination device 200 through the wireless network 260. The object identifier included in the aforementioned detection result is used in place of the terminal ID according to the example embodiment illustrated in FIG. 14 in the processing of the examination device 200.

The surveillance camera 282 and the authentication camera 581 that are provided on the gate 270 illustrated in FIG. 33, and the surveillance camera 240 and the authentication camera 530 in each area 210 may be replaced with a single camera combining functions of the cameras.

The present invention has been described above with the aforementioned example embodiments as exemplary examples. However, the present invention is not limited to the aforementioned example embodiments. In other words, various aspects that may be understood by a person skilled in the art may be applied to the present invention, within the scope of the present invention.

This application claims priority based on Japanese Patent Application No. 2016-083313 filed on Apr. 19, 2016, the disclosure of which is hereby incorporated by reference thereto in its entirety.

The aforementioned example embodiments may also be described in part or in whole as the following Supplementary Notes but are not limited thereto.

### <Supplementary Note 1>

An examination device including:
an intra-area object detection unit that detects an individually identifiable first object, the individually identifiable first object existing in each area of a first area and a second area where an object group in which the first object and an individually unidentifiable second object coexist goes in and out;
a first object count calculation unit that calculates a number of the first object that moves from the first area to the second area, using a detection result by the intra-area object detection unit; and
a moving object count calculation unit that calculates a total count of the first object and the second object that move from the first area to the second area, using the calculated number of the first object and a ratio between the number of the first objects and the number of the the second objects in the object group.

### <Supplementary Note 2>

The examination device according to Supplementary Note 1, further including:
an intra-area object count detection unit that detects a total count of the first object and the second object that exist in at least either area of the first area and the second area; and
a ratio calculation unit that calculates the ratio, using a detection result by the intra-area object count detection unit and the detection result by the intra-area object detection unit.

### <Supplementary Note 3>

The examination device according to Supplementary Note 1, further including:
a passing object detection unit that detects the first object and the second object that pass through a gate through which the first object and the second object that enter the first area and the second area pass; and
a ratio calculation unit that calculates the ratio, based on a detection result by the passing object detection unit.

### <Supplementary Note 4>

The examination device according to any one of Supplementary Notes 1 to 3, wherein,
in order to detect the first object, the intra-area object detection unit detects terminal identification information for identifying a terminal from a wireless frame transmitted from the terminal carried by the first object that exists in the area.

### <Supplementary Note 5>

The examination device according to any one of Supplementary Notes 1 to 3, wherein,
in order to detect the first object, the intra-area object detection unit performs authentication, based on an image acquired by photographing the first object that exists in the area by a camera and detects object identification information.

### <Supplementary Note 6>

The examination device according to Supplementary Note 1, wherein
the intra-area object detection unit detects an attribute of the first object that exists in each area of the first area and the second area,
the first object count calculation unit calculates, for the each attribute, a number of the first object that moves from the first area to the second area, based on a detection result by the intra-area object detection unit, and
the moving object count calculation unit calculates, for the each attribute, a total count of the first object and the second object that move from the first area to the second area, based on the calculated number of the first object for the each attribute and a ratio between the first object and the second object in the object group for the each attribute.

### <Supplementary Note 7>

The examination device according to Supplementary Note 6, further including:
a per-attribute intra-area object count detection unit that detects, for the each attribute, a number of the first object that exists in at least either area of the first area and the second area; and
a per-attribute ratio calculation unit that calculates, for the each attribute, the ratio, based on a detection result by the per-attribute intra-area object count detection unit and a detection result by the intra-area object detection unit.

### <Supplementary Note 8>

The examination device according to Supplementary Note 6, further including:
a passing object detection unit that detects an attribute of the first object and the second object that pass through a gate through which the first object and the second object that enter the first area and the second area pass; and
a per-attribute ratio calculation unit that calculates, for the each attribute, the ratio, based on a detection result by the passing object detection unit.

### <Supplementary Note 9>

The examination device according to any one of Supplementary Notes 6 to 8, wherein,
in order to detect an attribute of the first object, the intra-area object detection unit detects terminal identification information for identifying a terminal from a wireless frame transmitted from the terminal carried by the first object that exists in the area and determines the attribute related to the detected terminal identification information, based on information representing a relation between the terminal identification information and the attribute.

### <Supplementary Note 10>

The examination device according to Supplementary Note 9, further including
a passing object detection unit that detects, for the each first object that passes through a gate through which the first object that enters the first area and the second area passes, the terminal identification information for identifying a terminal and an attribute of the first object from a wireless frame transmitted from the terminal carried by the first object, and generates information representing a relation between the terminal identification information and the attribute.

### <Supplementary Note 11>

The examination device according to any one of Supplementary Notes 6 to 8, wherein,
in order to detect an attribute of the first object, the intra-area object detection unit detects object identification information by performing authentication, based on an image acquired by photographing the first object that exists in the area by a camera, and determines the attribute related to the detected object identification information, based on information representing a relation between the object identification information and the attribute.

### <Supplementary Note 12>

An object flow rate examination method including:
detecting an individually identifiable first object that exists in each area of a first area and a second area where an object group in which the first object and an individually unidentifiable second object coexist goes in and out;
calculating a number of the first object that moves from the first area to the second area, based on the detection result; and
calculating a total count of the first object and the second object that move from the first area to the second area, based on the calculated number of the first object and a ratio between the first object and the second object in the object group.

### <Supplementary Note 13>

The object flow rate examination method according to Supplementary Note 12, further including:
detecting a total count of the first object and the second object that exist in at least either area of the first area and the second area; and
calculating the ratio, based on a detection result of the total count and a detection result of the first object.

### <Supplementary Note 14>

The object flow rate examination method according to Supplementary Note 12, further including:
detecting the first object and the second object that pass through a gate through which the first object and the second object that enter the first area and the second area pass; and
calculating the ratio, based on a detection result of the first object and the second object that pass through the gate.

### <Supplementary Note 15>

The object flow rate examination method according to any one of Supplementary Notes 12 to 14, further including,
in detection of the first object, detecting terminal identification information for identifying a terminal from a wireless frame transmitted from the terminal carried by the first object that exists in the area.

### <Supplementary Note 16>

The object flow rate examination method according to any one of Supplementary Notes 12 to 14, further including,
in detection of the first object, detecting object identification information by performing authentication, based on an image acquired by photographing the first object that exists in the area by a camera.

### <Supplementary Note 17>

The object flow rate examination method according to Supplementary Note 12, further including:
in detection of the first object, detecting an attribute of the first object that exists in each area of the first area and the second area;
in calculation of a number of the first object, calculating, for the each attribute, a number of the first object that moves from the first area to the second area, based on a detection result of an attribute of the first object; and
in calculation of the total count, calculating, for the each attribute, a total count of the first object and the second object that move from the first area to the second area, based on the calculated number of the first object for the each attribute and a ratio between the first object and the second object in the object group for the each attribute.

### <Supplementary Note 18>

The object flow rate examination method according to Supplementary Note 15, further including:
detecting, for the each attribute, a number of the first object that exists in at least either area of the first area and the second area; and calculating, for the each attribute, the ratio, based on a detection result of the number and a detection result of the first object.

### <Supplementary Note 19>

The object flow rate examination method according to Supplementary Note 15, further including:
detecting an attribute of the first object and the second object that pass through a gate through which the first object and the second object that enter the first area and the second area pass; and
calculating, for the each attribute, the ratio, based on a detection result of the attribute.

### <Supplementary Note 20>

The object flow rate examination method according to any one of Supplementary Notes 17 to 19, further including,
in detection of an attribute of the first object, detecting terminal identification information for identifying a terminal from a wireless frame transmitted from the terminal carried by the first object that exists in the area and determining the attribute related to the detected terminal identification information, based on information representing a relation between the terminal identification information and the attribute.

### <Supplementary Note 21>

The object flow rate examination method according to Supplementary Note 20, further including,
for the each first object that passes through a gate through which the first object that enters the first area and the second area passes, detecting the terminal identification information for identifying a terminal and an attribute of the first object from a wireless frame transmitted from the terminal carried by the first object, and generating information representing a relation between the terminal identification information and the attribute.

### <Supplementary Note 22>

The object flow rate examination method according to any one of Supplementary Notes 17 to 19, further including,
in detection of an attribute of the first object, detecting object identification information by performing authentication, based on an image acquired by photographing the first object that exists in the area by a camera, and determining the attribute related to the detected object identification information, based on information representing a relation between the object identification information and the attribute.

### <Supplementary Note 23>

A program for causing a computer to function as:
an intra-area object detection unit that detects an individually identifiable first object that exists in each area of a first area and a second area where an object group in which the first object and an individually unidentifiable second object coexist goes in and out;
a first object count calculation unit that calculates a number of the first object that moves from the first area to the second area, based on a detection result by the intra-area object detection unit; and
a moving object count calculation unit that calculates a total count of the first object and the second object that move from the first area to the second area, based on the calculated number of the first object and a ratio between the first object and the second object in the object group.

### INDUSTRIAL APPLICABILITY

The present invention can be used in a field of examining a number of persons existing in a specific area, a number of persons moving between specific areas, and the like, for purposes of a traffic survey, facility management, marketing research, and the like.

### REFERENCE SIGNS LIST

100, 200, 300 Examination device

110, 210 Area

150, 250 Mobile terminal

1051 Total count detection unit

1052 Detection unit

1053 Movement count calculation unit

1054 Ratio calculation unit

1055 Estimation unit

2051 Per-attribute total count detection unit

2052 Per-attribute detection unit

2053 Per-attribute movement count calculation unit

2054 Per-attribute ratio calculation unit

2055 Per-attribute estimation unit

1. An examination device comprising:
a processor that is configured to:
detect an identified object in a first area and a second area, the identified object being individually identifiable object, the first area and the second area being areas where the identified object and an unidentified object difficult to individually identify coexist;
calculate a movement count of the identified object that moves from the first area to the second area using a detection result; and
estimate a total movement count of the identified object and the unidentified object that move from the first area to the second area using the calculated movement count of the identified object and a ratio between the identified object and the unidentified object for each of the areas.

2. The examination device according to claim 1, wherein the processor is configured further to:
detect a total count of the identified object and the unidentified object in at least either area of the first area and the second area; and
calculate the ratio using a the detected total count and a detection result of the identified object.

3. The examination device according to claim 1, wherein the processor is configured further to:
detect the identified object and the unidentified object that pass through a gate through which the identified object and the unidentified object entering the first area and the second area pass; and
calculate the ratio using a detection result of the identified object and the unidentified object that pass through the gate.

4. The examination device according to claim 1, wherein
the processor detects the identified object by use of terminal identification information on identifying a terminal carried by the identified object, the information being included in a wireless frame transmitted from the terminal.

5. The examination device according to claim 1, wherein
the processor detects the identified object in the area using an image captured inside the area by a camera.

6. The examination device according to claim 1, wherein
the processor further detects an attribute of the identified object in each area of the first area and the second area,
the processor calculates, for each of the attribute, the movement count of the identified object that moves from the first area to the second area using the detection result of the identified object, and
the processor estimates, for each of the attribute, the total movement count of the identified object and the unidentified object that move from the first area to the second area using the calculated movement count of the identified object for the each attribute and the ratio between the identified object and the unidentified object for the each attribute.

7. The examination device according to claim 6, wherein the processor is configured further to:
detect, for each of the attribute, a number of the identified objects in at least either area of the first area and the second area; and
calculate, for each of the attribute, the ratio, using a detection result of the number of the identified objects.

8. The examination device according to claim 6, wherein the processor is configured further to:
detect an attribute of the identified object and the unidentified object that pass through a gate through which the identified object and the unidentified object entering the first area and the second area pass; and
calculate, for each of the attribute, the ratio, using a detection result of the identified object and the unidentified object that pass through the gate.

9. The examination device according to claim 6, wherein
the processor detects the identified object by using terminal identification information on identifying a terminal carried by the identified object, the information being included in a wireless frame transmitted from the terminal, and determines the attribute to be associated with the detected terminal identification information using information representing a relation between the terminal identification information and the attribute.

10. The examination device according to claim 9, wherein,
the processor, for each identified object, detects an attribute of the identified object that passes through a gate through which the identified object entering the first area and the second area passes, and generates information representing a relation between the terminal identification information of the terminal carried by the identified object and the attribute of the identified object.

11. The examination device according to claim 6, wherein
the processor detects object identification information on identifying the identified object in the area using an image captured inside the area by a camera, and determines the attribute to be associated with the detected object identification information using information representing a relation between the object identification information and the attribute.

12. An examination method comprising:
by a processor,
detecting an identified object in a first area and a second area, the identified object being individually identifiable object, the first area and the second area being areas where the identified object and an unidentified object difficult to individually identify coexist;
calculating a movement count of the identified object that moves from the first area to the second area using a result of the detection; and
estimating a total movement count of the identified object and the unidentified object that move from the first area to the second area using the calculated movement count of the identified object and a ratio between the identified object and the unidentified object for each of the areas.

13.-22. (canceled)

23. A non-transitory program storage medium storing a computer program for causing a computer to execute:
detecting an identified object in a first area and a second area, the identified object being individually identifiable object, the first area and the second area being areas where the identified object and an unidentified object difficult to individually identify coexist;
calculating a movement count of the identified object that moves from the first area to the second area using a result of the detection; and
estimating a total movement count of the identified object and the unidentified object that move from the first area to the second area using the calculated movement count of the identified object and a ratio between the identified object and the unidentified object for each of the areas.
